(19) United States
(12) Patent Application Publication
(10) Pub. No.: US 2016/0132491 A1
(43) Pub. Date: May 12, 2016

(54) BILINGUAL PHRASE LEARNING APPARATUS, STATISTICAL MACHINE TRANSLATION APPARATUS, BILINGUAL PHRASE LEARNING METHOD, AND STORAGE MEDIUM

(71) Applicant: NATIONAL INSTITUTE OF INFORMATION AND COMMUNICATIONS TECHNOLOGY, Tokyo (JP)

(72) Inventors: Taro WATANABE, Tokyo (JP); Conghui ZHU, Tokyo (JP); Eiichiro SUMITA, Tokyo (JP)

(73) Assignee: National Institute of Information and Communications Technology, Tokyo (JP)

(21) Appl. No.: 14/898,431

(22) PCT Filed: May 23, 2014
(86) PCT No.: PCT/JP2014/063668

§ 371 Date: Dec. 14, 2015

(51) Int. Cl. G06F 17/28; G06F 17/27

(52) U.S. Cl. CPC G06F 17/2818; G06F 17/2775; G06F 17/2715

(57) ABSTRACT

In order to solve a conventional problem that a translation model has to be updated each time a translation corpus is added, in a case of calculating a score of each phrase pair acquired from a j-th translation corpus (2≦j≦N) (added translation corpus), a score of each phrase pair corresponding to the j-th translation corpus is calculated using the one or more pieces of phrase appearance frequency information corresponding to a (j−1)-th translation corpus, the calculated score is used to generate a translation model, and the newly generated translation model is used in a state of being integrated to an original translation model. Accordingly, a translation model can be easily enhanced in a stepwise manner.

### TECHNICAL FIELD

The present invention relates to a bilingual phrase learning apparatus and the like for learning bilingual phrases.

### BACKGROUND ART

In conventional statistical machine translation (see Non-Patent Document 1), translation models are trained by extracting bilingual knowledge such as phrase tables from bilingual data. Translation systems are realized based on the translation models. In order to estimate an accurate translation model, training has to be performed with a large amount of bilingual data using a training method called batch training. The batch training is a training method that optimizes all training data.

In particular, the amount of bilingual data increases every year, and, in conventional techniques, retraining has to be performed each time data is added. However, it is not ensured that a better translation model is estimated as a result of this retraining.

In order to solve this problem, conventionally, there has been a method that splits bilingual data into groups of respective domains, trains local translation models in the respective domains, and combines the translation models (see Non-Patent Document 2).

Furthermore, in conventional techniques, there has been an approach using a distinguishing device that properly allocates domains to an input sentence in a source language (see Non-Patent Document 3).

Furthermore, in conventional techniques, there has been an approach that adds a domain-dependent feature, and optimizes a parameter thereof for bilingual data provided with a label of that domain (see Non-Patent Documents 3 to 6).

Furthermore, in conventional techniques, there has been an approach called incremental retraining in which, each time bilingual data is added, the model is updated in accordance with the added data (see Non-Patent Document 7).

### CITATION LIST

### Non-Patent Document

[Non-Patent Document 1] Philipp Koehn, Franz Josef Och, and Daniel Marcu. 2003. Statistical phrase-based translation. In Proc. HLT.
[Non-Patent Document 2] George Foster and Roland Kuhn. 2007. Mixture-model adaptation for smt. In Proc. of the second workshop of SMT.
[Non-Patent Document 3] Jia Xu, Yonggang Deng, Yuqing Gao, and Hermann Ney. 2007. Domain dependent statistical machine translation. MT Summit XI.
[Non-Patent Document 4] Wei Wang, Klaus Macherey, Wolfgang Macherey, Franz Och, and Peng Xu. 2012. Improved domain adaptation for statistical machine translation. In Proc. of AMTA.
[Non-Patent Document 5] Yajuan Lu, Jin Huang, and Qun Liu. 2007. Improving statistical machine translation performance by training data selection and optimization. In Proceedings of the 2007 Joint Conference on Empirical Methods in Natural Language Processing and Computational Natural Language Learning (EMNLP-CoNLL), pages 343-350.
[Non-Patent Document 6] Jinsong Su, Hua Wu, Haifeng Wang, Yidong Chen, Xiaodong Shi, Huailin Dong, and Qun Liu. 2012. Translation model adaptation for statistical machine translation with monolingual topic information. In Proc. of ACL.
[Non-Patent Document 7] Abby Levenberg, Chris Callison-Burch, and Miles Osborne. 2010. Stream-based translation models for statistical machine translation. In Human Language Technologies: The 2010 Annual Conference of the North American Chapter of the Association for Computational Linguistics, HLT'10, pages 394-402, Stroudsburg, Pa., USA. Association for Computational Linguistics.

### DISCLOSURE OF INVENTION

### Problems to be Solved by the Invention

However, the above-described approaches using domain adaptation are problematic in that, if training is locally performed in each domain, the amount of bilingual data is small, making it impossible to accurately estimate a translation model. Furthermore, the approaches using domain adaptation require a distinguishing device in order to determine a weight for each domain or to distinguish domains of an input sentence. In particular, the techniques according to Non-Patent Documents 2 and 3 require a distinguishing device that allocates proper domains to an input sentence, resulting in a problem that the translation precision depends on the performance of that distinguishing device.

Furthermore, the feature-based approaches according to Non-Patent Documents 4 to 6 are problematic in that accurate bilingual data provided with a label of each domain is required.

Furthermore, the incremental retraining according to Non-Patent Document 7 is problematic in that this retraining is based on a technique that requires complicated parameter adjustment, such as an online EM algorithm, and the system becomes complicated such as requiring further optimization of added translation models.

In summary, conventional techniques require an inordinate amount of effort in processing that enhances a translation model in a stepwise manner each time a translation corpus is added.

The present invention was arrived at in view of these circumstances, and it is an object thereof to make it possible to easily enhance a translation model in a stepwise manner, by using a translation model generated from an added translation corpus in a state of being integrated to an original translation model.

### Means for Solving the Problems

A first aspect of the present invention is directed to a bilingual phrase learning apparatus, including: a bilingual information storage unit in which N translation corpuses (N is a natural number of 2 or more) each having one or more pieces of bilingual information, each of which has a pair of original and translated sentences and a tree structure of the pair of original and translated sentences, can be stored; a phrase table in which one or more scored phrase pairs each having a phrase pair, which is a pair of a first language phrase having one or more words in a first language and a second language phrase having one or more words in a second language, and a score, which is information regarding an appearance probability of the phrase pair, can be stored for each translation corpus; a phrase appearance frequency information storage unit in which one or more pieces of phrase appearance frequency information each having a phrase pair and F appearance frequency information, which is information regarding an appearance frequency of the phrase pair, can be stored for each translation corpus; a symbol appearance frequency information storage unit in which one or more pieces of symbol appearance frequency information each having a symbol for identifying a method for generating a new phrase pair and S appearance frequency information, which is information regarding an appearance frequency of the symbol, can be stored; a generated phrase pair acquiring unit that acquires, for each translation corpus, a phrase pair having a first language phrase and a second language phrase, using the one or more pieces of phrase appearance frequency information; a phrase appearance frequency information updating unit that, in a case where a phrase pair has been acquired, increases the F appearance frequency information corresponding to the phrase pair, by a predetermined value; a symbol acquiring unit that, in a case where a phrase pair has not been acquired, acquires one symbol, using the one or more pieces of symbol appearance frequency information; a symbol appearance frequency information updating unit that increases the S appearance frequency information corresponding to the symbol acquired by the symbol acquiring unit, by a predetermined value; a partial phrase pair generating unit that, in a case where a phrase pair has not been acquired, generates two phrase pairs smaller than the phrase pair intended to be acquired; a new phrase pair generating unit that performs one of first processing, second processing, and third processing, according to the symbol acquired by the symbol acquiring unit, the first processing being processing that generates a new phrase pair, the second processing being processing that generates two smaller phrase pairs, and generates one phrase pair having a new first language phrase obtained by integrating, in forward order, two first language phrases forming the generated two phrase pairs and a new second language phrase obtained by integrating, in forward order, two second language phrases forming the two phrase pairs, using the one or more pieces of phrase appearance frequency information, and third processing being processing that generates two smaller phrase pairs, and generates one phrase pair having a new first language phrase obtained by integrating, in forward order, two first language phrases forming the generated two phrase pairs and a new second language phrase obtained by integrating, in inverse order, two second language phrases forming the two phrase pairs, using the one or more pieces of phrase appearance frequency information; a control unit that gives an instruction to recursively perform the processing by the phrase appearance frequency information updating unit, the symbol acquiring unit, the symbol appearance frequency information updating unit, the partial phrase pair generating unit, and the new phrase pair generating unit, on the phrase pair generated by the new phrase pair generating unit; a score calculating unit that calculates a score of each phrase pair in the phrase table, using the one or more pieces of phrase appearance frequency information stored in the phrase appearance frequency information storage unit; and a phrase table updating unit that accumulates the score calculated by the score calculating unit, in association with the corresponding phrase pair; wherein, in a case of calculating a score of each phrase pair acquired from a j-th translation corpus (2≦j≦N), the score calculating unit calculates a score of each phrase pair corresponding to the j-th translation corpus, using the one or more pieces of phrase appearance frequency information corresponding to a (j−1)-th translation corpus.

With this configuration, a translation model can be easily enhanced in a stepwise manner.

Furthermore, a second aspect of the present invention is directed to the bilingual phrase learning apparatus according to the first aspect, wherein one or more translation corpuses are stored in the bilingual information storage unit, the bilingual phrase learning apparatus further includes: a translation corpus accepting unit that accepts a translation corpus; and a translation corpus accumulating unit that accumulates the translation corpus accepted by the translation corpus accepting unit, in the bilingual information storage unit; after the translation corpus accumulating unit accumulates the accepted translation corpus in the bilingual information storage unit, the control unit gives an instruction to perform the processing by the generated phrase pair acquiring unit, the phrase appearance frequency information updating unit, the symbol acquiring unit, the symbol appearance frequency information updating unit, the partial phrase pair generating unit, and the new phrase pair generating unit, on the translation corpus, and in a case of calculating a score of each phrase pair acquired from the translation corpus accepted by the translation corpus accepting unit, the score calculating unit calculates a score of each phrase pair corresponding to the translation corpus accepted by the translation corpus accepting unit, using the one or more pieces of phrase appearance frequency information corresponding to one translation corpus among the one or more translation corpuses stored in the bilingual information storage unit before the translation corpus accumulating unit accumulates the translation corpus.

With this configuration, a translation model can be easily enhanced in a stepwise manner.

Furthermore, a third aspect of the present invention is directed to the bilingual phrase learning apparatus according to the first aspect, further including: a translation corpus generating unit that splits two or more pairs of original and translated sentences into N groups, and accumulates N translation corpuses generated by acquiring tree structures of pairs of original and translated sentences from the pairs of original and translated sentences in the respective groups, in the bilingual information storage unit; wherein, in a case of calculating a score of each phrase pair acquired from one translation corpus, the score calculating unit calculates a score of each phrase pair corresponding to the one translation corpus, using the one or more pieces of phrase appearance frequency information corresponding to a translation corpus different from the one translation corpus.

With this configuration, a translation model can be easily enhanced in a stepwise manner.

Furthermore, a fourth aspect of the present invention is directed to the bilingual phrase learning apparatus according to any one of the first to third aspects, wherein the score calculating unit calculates a score of each phrase pair corresponding to a translation corpus, using a hierarchical Chinese restaurant process.

With this configuration, a translation model can be easily enhanced in a stepwise manner using the hierarchical Chinese restaurant process.

Furthermore, a fifth aspect of the present invention is directed to a statistical machine translation apparatus, including: a phrase table learned by the bilingual phrase learning apparatus according to any one of the first to fourth aspects; an accepting unit that accepts a sentence in a first language having one or more words; a phrase acquiring unit that extracts one or more phrases from the sentence accepted by the accepting unit, and acquires one or more phrases in a second language from the phrase table, using a score in the phrase table; a sentence constructing unit that constructs a sentence in the second language, from the one or more phrases acquired by the phrase acquiring unit; and an output unit that outputs the sentence constructed by the sentence constructing unit.

With this configuration, precise machine translation can be realized using a translation model enhanced in a stepwise manner.

### Effect of the Invention

The bilingual phrase learning apparatus according to the present invention can easily enhance a translation model in a stepwise manner.

### BRIEF DESCRIPTION OF THE DRAWINGS

FIG. 1 is a block diagram of a bilingual phrase learning apparatus 1 in Embodiment 1 of the present invention.

FIG. 2 is a flowchart illustrating an operation of the bilingual phrase learning apparatus 1 in Embodiment 1 of the present invention.

FIG. 3 is a flowchart illustrating phrase generation processing in Embodiment 1 of the present invention.

FIG. 4 is a diagram showing an example of a tree structure forming bilingual information in Embodiment 1 of the present invention.

FIG. 5 is a block diagram of a bilingual phrase learning apparatus 2 in Embodiment 2 of the present invention.

FIG. 6 is a flowchart illustrating an operation of the bilingual phrase learning apparatus 2 in Embodiment 2 of the present invention.

FIG. 7 is a block diagram of a statistical machine translation apparatus 3 in Embodiment 3 of the present invention.

FIG. 8 is a table illustrating data sets used in an experiment in the embodiment of the present invention.

FIG. 9 is a table showing an experimental result in the embodiment of the present invention.

FIG. 10 is a table showing an experimental result in the embodiment of the present invention.

FIG. 11 is a table showing an experimental result in the embodiment of the present invention.

FIG. 12 is a schematic view of a computer system in the embodiments of the present invention.

FIG. 13 is a block diagram of the computer system in the embodiments of the present invention.

### DESCRIPTION OF EMBODIMENTS

Hereinafter, embodiments of a bilingual phrase learning apparatus and the like will be described with reference to the drawings. Note that constituent elements denoted by the same reference numerals perform similar operations in the embodiments, and, thus, a description thereof may not be repeated.

### Embodiment 1

In this embodiment, a bilingual phrase learning apparatus will be described that can easily enhance a translation model in a stepwise manner, by integrating a translation model generated from an added translation corpus, to an original translation model.

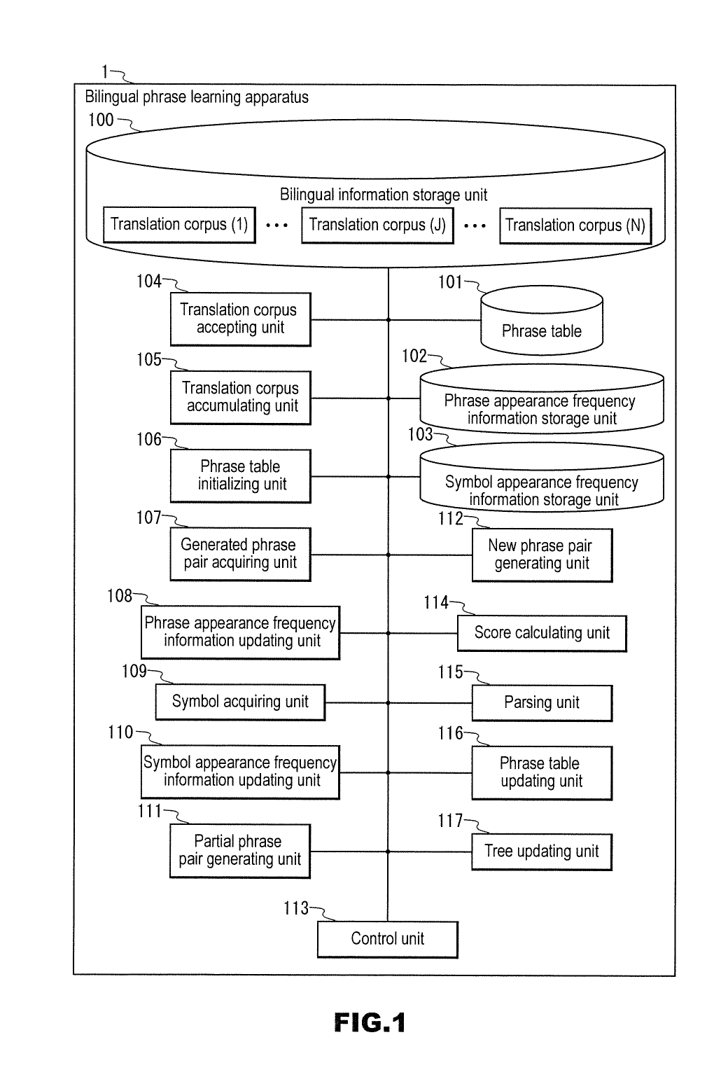

FIG. 1 is a block diagram of a bilingual phrase learning apparatus 1 in this embodiment.

The bilingual phrase learning apparatus 1 includes a bilingual information storage unit 100, a phrase table 101, a phrase appearance frequency information storage unit 102, a symbol appearance frequency information storage unit 103, a translation corpus accepting unit 104, a translation corpus accumulating unit 105, a phrase table initializing unit 106, a generated phrase pair acquiring unit 107, a phrase appearance frequency information updating unit 108, a symbol acquiring unit 109, a symbol appearance frequency information updating unit 110, a partial phrase pair generating unit 111, a new phrase pair generating unit 112, a control unit 113, a score calculating unit 114, a parsing unit 115, a phrase table updating unit 116, and a tree updating unit 117.

In the bilingual information storage unit 100, N translation corpuses (N is a natural number of 2, 3, or more) can be stored. Each of the translation corpuses has one or more pieces of bilingual information. The bilingual information has a pair of original and translated sentences, and a tree structure of the pair of original and translated sentences. The pair of original and translated sentences is a pair of a first language sentence and a second language sentence. The first language sentence is a sentence in a first language. The second language sentence is a sentence in a second language. The sentence refers to one or more words, and may refer to a phrase. The tree structure of the pair of original and translated sentences is information in which correspondences between phrases (or words) obtained by splitting each of the two language sentences are expressed as a tree structure.

Note that one translation corpus may be already stored in the bilingual information storage unit 100 before processing, after which one or more translation corpuses may be accumulated as the second and following translation corpuses.

In the phrase table 101, one or more scored phrase pairs can be stored for each of the N translation corpuses. Each of the scored phrase pairs has a phrase pair and a score. The phrase pair is a pair of a first language phrase and a second language phrase. The first language phrase is a phrase having one or more words in a first language. The second language phrase is a phrase having one or more words in a second language. It is assumed that the phrase is broadly interpreted so as to encompass a sentence. The score is information regarding an appearance probability of a phrase pair. The score is, for example, a phrase pair probability θₜ. It is assumed that the phrase pair is a concept broadly interpreted so as to encompass a rule pair. The one or more scored phrase pairs may be interpreted to be the same as the translation model described above.

In the phrase appearance frequency information storage unit 102, one or more pieces of phrase appearance frequency information can be stored for each translation corpus. The phrase appearance frequency information has a phrase pair and F appearance frequency information. The F appearance frequency information is information regarding an appearance frequency of a phrase pair. The F appearance frequency information is preferably an appearance frequency of a phrase pair, but also may be an appearance probability of a phrase pair, or the like. The initial values of the F appearance frequency information are, for example, 0 for all phrase pairs.

In the symbol appearance frequency information storage unit 103, one or more pieces of symbol appearance frequency information can be stored. The symbol appearance frequency information has a symbol and S appearance frequency information. The symbol is information for identifying a method for generating a new phrase pair. The symbol is, for example, any one of BASE, REG, and INV. Note that BASE is a symbol indicating that a phrase pair is to be generated from a base measure, REG is a regular non-terminal symbol, and INV is an inversion non-terminal symbol. The S appearance frequency information is information regarding an appearance frequency of a symbol. The S appearance frequency information is preferably an appearance frequency of a symbol, but also may be an appearance probability of a symbol, or the like. The initial values of the S appearance frequency information are, for example, 0 for all the three symbols. The base measure is, for example, a prior probability calculated using a word translation model such as the IBM Model 1 and is a known art, and, thus, a detailed description thereof has been omitted.

The translation corpus accepting unit 104 accepts a translation corpus. The accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory, and the like.

The translation corpus may be input through any part such as a keyboard, a mouse, a menu screen, or the like. The translation corpus accepting unit 104 may be realized by a device driver for an input part such as a keyboard, control software for a menu screen, or the like.

The translation corpus accumulating unit 105 accumulates the translation corpus accepted by the translation corpus accepting unit 104, in the bilingual information storage unit 100.

The phrase table initializing unit 106 generates initial information of the one or more scored phrase pairs, from the one or more pieces of bilingual information of the translation corpus, and accumulates it in the phrase table 101. For example, the phrase table initializing unit 106 acquires a phrase pair that appears in a tree structure of a pair of original and translated sentences contained in the one or more pieces of bilingual information, and the number of times of the appearance, as a scored phrase pair, and accumulates them in the phrase table 101. In this case, the score is the number of times of the appearance. Typically, the phrase table initializing unit 106 generates, for each translation corpus, initial information of the one or more scored phrase pairs, and accumulates it in the phrase table 101. The phrase table initializing unit 106 may generate initial information of the one or more scored phrase pairs from the one or more pieces of bilingual information contained in the translation corpus accepted by the translation corpus accepting unit 104, and accumulate it in the phrase table 101.

The generated phrase pair acquiring unit 107 acquires, for each translation corpus, a phrase pair having a first language phrase and a second language phrase, using the one or more pieces of phrase appearance frequency information.

The generated phrase pair acquiring unit 107 acquires, for each translation corpus, each of the one or more pairs of original and translated sentences stored in the translation corpus, and subtracts the value (typically, the appearance frequency “1”) corresponding to the appearance of each of the one or more phrase pairs forming a tree structure of the pair of original and translated sentences, from the score of the phrase pair in the phrase table 101. Next, the generated phrase pair acquiring unit 107 acquires (strictly speaking, intends to acquire) a phrase pair having a first language phrase and a second language phrase, using the one or more pieces of phrase appearance frequency information. The using the one or more pieces of phrase appearance frequency information may be, for example, using a phrase pair probability distribution Pₜ. That is to say, the generated phrase pair acquiring unit 107 preferably acquires a phrase pair having a first language phrase and a second language phrase, using the phrase pair probability distribution Pₜ.

In the case where the generated phrase pair acquiring unit 107 or the new phrase pair generating unit 112 has acquired a phrase pair, the phrase appearance frequency information updating unit 108 increases the F appearance frequency information corresponding to the phrase pair, by a predetermined value. The F appearance frequency information is typically an appearance frequency of a phrase pair. The predetermined value is typically 1.

In the case where the generated phrase pair acquiring unit 107 or the like has not acquired a phrase pair, the symbol acquiring unit 109 acquires one symbol, using the one or more pieces of symbol appearance frequency information. The using the one or more pieces of symbol appearance frequency information is preferably using a symbol probability distribution Pₓ(x;θₓ). That is to say, in the case where the generated phrase pair acquiring unit 107 has not acquired a generated phrase pair, the symbol acquiring unit 109 preferably acquires one symbol, using the symbol probability distribution. The one symbol is, for example, any one of BASE, REG, and INV. Note that “x” of Pₓ(x;θₓ) is a symbol and (θₓ) is a probability that the symbol is to be used.

The symbol appearance frequency information updating unit 110 increases the S appearance frequency information corresponding to the symbol acquired by the symbol acquiring unit 109, by a predetermined value. The predetermined value is typically 1.

In the case where the generated phrase pair acquiring unit 107 or the like has not acquired a phrase pair, the partial phrase pair generating unit 111 generates two phrase pairs smaller than the phrase pair intended to be acquired. In the case where a phrase pair has not been acquired, the partial phrase pair generating unit 111 generates two phrase pairs smaller than the phrase pair intended to be acquired, typically using a prior probability of a phrase pair. More specifically, for example, in the case where a phrase pair in a j-th translation corpus is intended to be generated, the partial phrase pair generating unit 111 generates two phrase pairs smaller than the phrase pair intended to be acquired, using a prior probability P^{j-1} of a phrase pair in a (j−1)-th translation corpus. If j=1, the partial phrase pair generating unit 111 generates two phrase pairs smaller than the phrase pair intended to be acquired, using P_{base} (e.g., IBM Model 1). For example, if the phrase pair intended to be acquired is <red cookbook, [symbol] [symbol] , “P_{base}(<red cookbook, [symbol] >)=Pₓ(REG)*Pₜ(<red [symbol] >)*P_{t}(<cookbook, [symbol] >)+Pₓ(REG)*Pₜ(<redA, [symbol] >)*Pₜ(<cookbook, [symbol] >)+Pₓ(INV)*Pₜ(<red, [symbol] >)*Pₜ(<cookbook, [symbol] >)+Pₓ(INV)*Pₜ(<red, [symbol] >)*Pₜ(<cookbook, [symbol] >)+Pₓ(BASE)*P_{base}(<red cookbook, [symbol] >)”. Note that P_{base} is, for example, a prior probability calculated using a word translation model such as the IBM Model 1.

The new phrase pair generating unit 112 performs one of first processing, second processing, and third processing, according to the symbol acquired by the symbol acquiring unit 109. The new phrase pair generating unit 112 performs the first processing if the symbol acquired by the symbol acquiring unit 109 is BASE, performs the second processing if the symbol is REG, and performs the third processing if the symbol is INV

The first processing is processing that generates a new phrase pair. The first processing is processing that generates a new phrase pair, using a prior probability of a phrase pair. If the case where a j-th translation corpus (2≦j≦N) is being processed, the prior probability of the phrase pair that is to be used in the first processing is the prior probability of the phrase pair corresponding to a (j−1)-th translation corpus.

Furthermore, the second processing is processing that generates two smaller phrase pairs, and generates one phrase pair having a new first language phrase obtained by integrating, in forward order, two first language phrases forming the generated two phrase pairs and a new second language phrase obtained by integrating, in forward order, two second language phrases forming the two phrase pairs, using the one or more pieces of phrase appearance frequency information.

Furthermore, the third processing is processing that generates two smaller phrase pairs, and generates one phrase pair having a new first language phrase obtained by integrating, in forward order, two first language phrases forming the generated two phrase pairs and a new second language phrase obtained by integrating, in inverse order, two second language phrases forming the two phrase pairs, using the one or more pieces of phrase appearance frequency information. The using the one or more pieces of phrase appearance frequency information may be using a phrase pair generation probability (Pₕᵢₑᵣ).

The control unit 113 gives an instruction to recursively perform the processing by the phrase appearance frequency information updating unit 108, the symbol acquiring unit 109, the symbol appearance frequency information updating unit 110, the partial phrase pair generating unit 111, and the new phrase pair generating unit 112, on the phrase pair generated by the new phrase pair generating unit 112. The recursively performing typically refers to a situation in which, if the processing target is processed into a word pair, the recursive processing is ended. The recursive processing is ended if the processing target is processed to generate a phrase directly from Pₜ (without using the base measure). The recursive processing is ended if BASE is generated from Pₓ and a phrase pair is generated from P_{base}.

Furthermore, after the translation corpus accumulating unit 105 accumulates the accepted translation corpus in the bilingual information storage unit 100, the control unit 113 may give an instruction to perform the processing by the generated phrase pair acquiring unit 107, the phrase appearance frequency information updating unit 108, the symbol acquiring unit 109, the symbol appearance frequency information updating unit 110, the partial phrase pair generating unit 111, and the new phrase pair generating unit 112, on the translation corpus.

The score calculating unit 114 calculates a score of each phrase pair in the phrase table 101, using the one or more pieces of phrase appearance frequency information stored in the phrase appearance frequency information storage unit 102.

In the case of calculating a score of each phrase pair acquired from a j-th translation corpus (2≦j≦N), the score calculating unit 114 calculates a score of each phrase pair corresponding to the j-th translation corpus, using the one or more pieces of phrase appearance frequency information corresponding to a (j−1)-th translation corpus.

Furthermore, in the case of calculating a score of each phrase pair acquired from the translation corpus accepted by the translation corpus accepting unit 104, the score calculating unit 114 may calculate a score of each phrase pair corresponding to the translation corpus accepted by the translation corpus accepting unit 104, using the one or more pieces of phrase appearance frequency information corresponding to one translation corpus among the one or more translation corpuses stored in the bilingual information storage unit 100 before the translation corpus accumulating unit 105 accumulates the translation corpus.

Furthermore, the score calculating unit 114 may calculate a score of each phrase pair corresponding to a translation corpus, using a hierarchical Chinese restaurant process following Expression 1.

$$\begin{matrix}P ( 〈 f , e 〉 ; 〈 F , E 〉 ) = \frac{{c}_{〈 f , e 〉}^{J} {d}^{J} \times {t}_{〈 f , e 〉}^{J}}{{C}^{J} + {s}^{J}} + \\ \frac{{s}^{J} + {d}^{J} \times {T}^{J}}{{C}^{J} + {s}^{J}} \times \frac{{c}_{〈 f , e 〉}^{J - 1} - {d}^{J - 1} \times {t}_{〈 f , e 〉}^{J - 1}}{{C}^{J - 1} + {s}^{J - 1}} … + \\ {\prod }_{{j}^{′} = j + 1}^{J} \frac{{s}^{{j}^{′}} + {d}^{{j}^{′}} \times {T}^{{j}^{′}}}{{C}^{{j}^{′}} + {s}^{{j}^{′}}} \times \\ \frac{{c}_{〈 f , e 〉}^{j} - {d}^{j} \times {t}_{〈 f , e 〉}^{j}}{{C}^{j} + {s}^{j}} … + \\ {\prod }_{{j}^{′} = 1}^{J} \frac{{s}^{{j}^{′}} + {d}^{{j}^{′}} \times {T}^{{j}^{′}}}{{C}^{{j}^{′}} + {s}^{{j}^{′}}} \times {P}_{base}^{1} ( 〈 f , e 〉 )\end{matrix} \qquad Expression 1$$

As described above, the bilingual phrase learning apparatus 1 can be said to be an apparatus that does not estimate parameters of models of all bilingual data <F,E>, but learns part of the bilingual data only in a specific domain. Moreover, the bilingual phrase learning apparatus 1 can be said to be an apparatus that does not use a model such as the IBM Model 1 as the prior probability, but uses a model trained in another domain. Specifically, it is assumed that the bilingual data <F,E> is split into J domains <F¹,E¹> <F^{J},E^{J}>, and a parameter θₜ^{j} of a translation model of the j-th domain is learned from the bilingual data <F^{j},E^{j}> of the j-th domain, using a model P^{j-1} obtained in the (j−1)-th domain therebefore as the prior probability (see Expression 2). Note that the translation model of Expression 2 is referred to as a hierarchical Pitman-Yor model, and is used in, for example, the ngram language model or domain adaptation. If the hierarchical Pitman-Yor model is expressed as the hierarchical Chinese restaurant process, the hierarchical Pitman-Yor model is expressed as in Expression 1. Note that “F” of the bilingual data <F,E> is a source language sentence and “E” is a target language sentence (second language sentence).

θₜ^{J}˜PY(d^{J},s^{J},P^{J-1})

θₜ^{j}˜PY(d^{j},s^{j},P^{j-1})

θₜ¹˜PY(d¹,s¹,P_{base}¹) Expression 2

The parsing unit 115 acquires a tree structure of a pair of original and translated sentences (or phrases) with the largest score calculated by the score calculating unit 114. Specifically, the parsing unit 115 acquires a tree structure using an ITG chart parser. Note that the ITG chart parser is described in “M. Saers, J. Nivre, and D. Wu. Learning stochastic bracketing inversion transduction grammars with a cubic time biparsing algorithm. In Proc. IWPT, 2009.”.

The phrase table updating unit 116 accumulates the score calculated by the score calculating unit 114 in association with the corresponding phrase pair. If the phrase table 101 does not have the phrase pair corresponding to the score calculated by the score calculating unit 114, the phrase table updating unit 116 may accumulate a scored phrase pair having the score calculated by the score calculating unit 114 and the phrase pair, in the phrase table 101.

The tree updating unit 117 accumulates the tree structure acquired by the parsing unit 115, in the translation corpus. Typically, the tree updating unit 117 overwrites a tree structure. That is to say, an old tree structure in the translation corpus is updated to a new tree structure.

The bilingual information storage unit 100, the phrase table 101, the phrase appearance frequency information storage unit 102, and the symbol appearance frequency information storage unit 103 are preferably realized by a non-volatile storage medium, but may be realized also by a volatile storage medium.

There is no limitation on the procedure in which the translation corpus and the like are stored in the bilingual information storage unit 100 and the like. For example, the translation corpus and the like may be stored in the bilingual information storage unit 100 and the like via a storage medium, the translation corpus and the like transmitted via a communication line or the like may be stored in the bilingual information storage unit 100 and the like, or the translation corpus and the like input via an input device may be stored in the bilingual information storage unit 100 and the like.

The translation corpus accumulating unit 105, the phrase table initializing unit 106, the generated phrase pair acquiring unit 107, the phrase appearance frequency information updating unit 108, the symbol acquiring unit 109, the symbol appearance frequency information updating unit 110, the partial phrase pair generating unit 111, the new phrase pair generating unit 112, the control unit 113, the score calculating unit 114, the parsing unit 115, the phrase table updating unit 116, and the tree updating unit 117 may be realized typically by an MPU, a memory, or the like. Typically, the processing procedure of the translation corpus accumulating unit 105 and the like is realized by software, and the software is stored in a storage medium such as a ROM. Note that the processing procedure of the translation corpus accumulating unit 105 and the like may be realized also by hardware (a dedicated circuit).

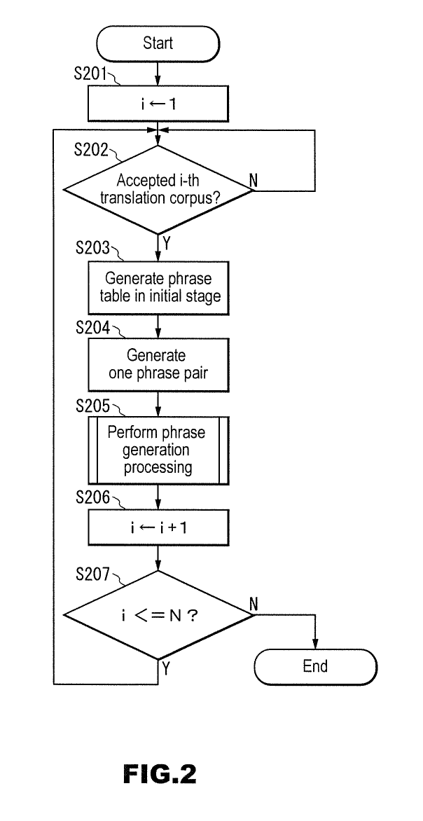

Next, an operation of the bilingual phrase learning apparatus 1 will be described with reference to the flowchart in FIG. 2. In this flowchart, the case will be described in which the bilingual phrase learning apparatus 1 sequentially accepts N translation corpuses (N is a natural number of 2, 3, or more) and uses a (j−1)-th phrase table to construct a phrase table from a j-th translation corpus (j<N).

(Step S201) The translation corpus accepting unit 104 substitutes 1 for a counter i.

(Step S202) The translation corpus accepting unit 104 judges whether or not an i-th translation corpus has been accepted. If an i-th translation corpus has been accepted, the procedure advances to step S203, and, if not, the procedure returns to step S202.

(Step S203) The phrase table initializing unit 106 generates initial information of the one or more scored phrase pairs, from the one or more pieces of bilingual information contained in the i-th translation corpus, and accumulates it in the phrase table 101 in association with i.

(Step S204) The generated phrase pair acquiring unit 107 acquires each of the one or more pairs of original and translated sentences contained in the translation corpus accepted in step S201, and subtracts the value (typically, the appearance frequency “1”) corresponding to the appearance of each of the one or more phrase pairs forming a tree structure of the pair of original and translated sentence, from the score of the phrase pair that is in the phrase table 101 and corresponds to i. Next, the generated phrase pair acquiring unit 107 intends to generate one phrase pair, using a probability distribution Pⁱ⁻¹ of the phrase pair corresponding to (i−1). If “i=1”, the generated phrase pair acquiring unit 107 intends to generate one phrase pair, using a probability distribution P_{base}. The probability distribution P_{base} is, for example, IBM Model 1. The probability distribution of the phrase pair may be calculated using the phrase pair frequency (F appearance frequency information) corresponding to (i−1), for example, following the Pitman-Yor process. The phrase pair frequency (F appearance frequency information) is stored in the phrase appearance frequency information storage unit 102. The calculation of the probability based on the Pitman-Yor process is a known art, and, thus, a description thereof has been omitted.

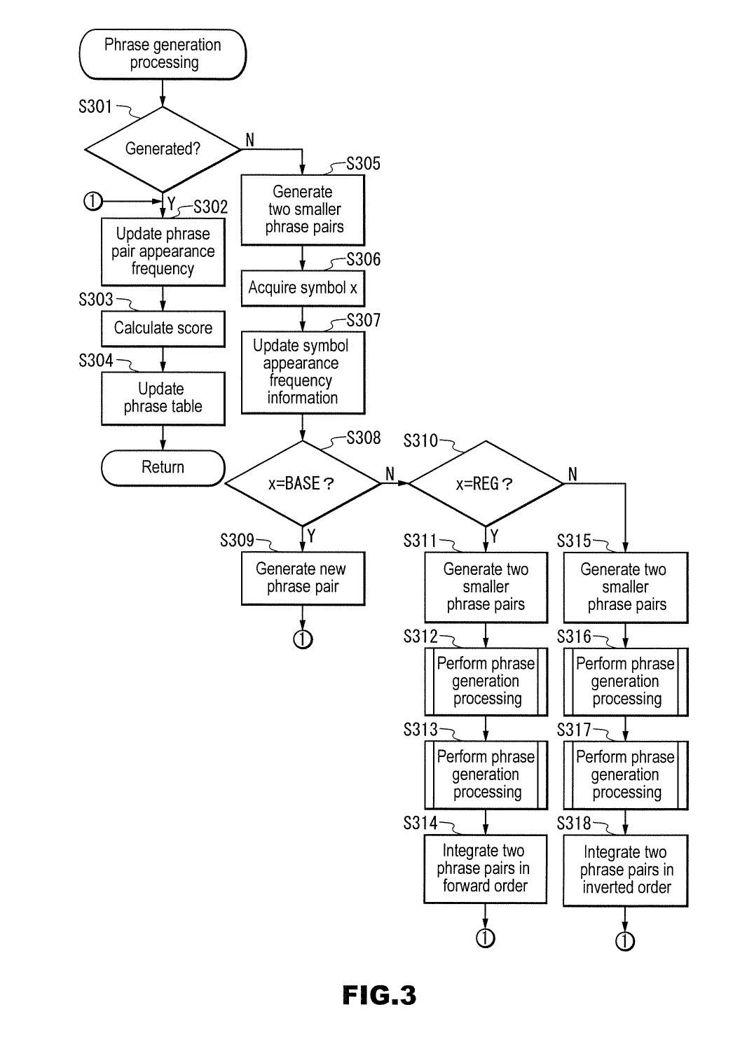

(Step S205) The partial phrase pair generating unit 111 and the like perform phrase generation processing. The phrase generation processing is, for example, processing that generates phrases in two or more levels using the hierarchical ITG. The phrase generation processing will be described in detail with reference to the flowchart in FIG. 3.

(Step S206) The translation corpus accepting unit 104 increments the counter i by 1.

(Step S207) The translation corpus accepting unit 104 judges whether or not “i≦N” is satisfied. If “i≦N” is satisfied, the procedure returns to step S202, and, if not, the procedure is ended.

Next, the phrase generation processing in step S205 will be described in detail with reference to the flowchart in FIG. 3.

(Step S301) The partial phrase pair generating unit 111 judges whether or not a phrase pair has been generated in previous phrase pair generation processing. If a phrase pair has been generated, the procedure advances to step S302, and, if not, the procedure advances to step S305.

(Step S302) The phrase appearance frequency information updating unit 108 increases the F appearance frequency information corresponding to the phrase pair generated in the previous phrase pair generation processing, by a predetermined value (typically “1”). If the phrase appearance frequency information storage unit 102 does not have the phrase pair, the phrase appearance frequency information updating unit 108 accumulates the generated phrase pair and the F appearance frequency information in association with each other, in the phrase appearance frequency information storage unit 102.

(Step S303) The score calculating unit 114 calculates a score of the phrase pair corresponding to the updated phrase appearance frequency information. In the case of calculating a score of this phrase pair, the score calculating unit 114 uses the phrase appearance frequency information corresponding to (i−1) (see Expressions 1 and 2).

(Step S304) The phrase table updating unit 116 constructs a scored phrase pair having the score calculated in step S303, and writes it to the phrase table 101. If the phrase table 101 does not have the phrase pair, the phrase table updating unit 116 constructs a scored phrase pair and newly adds it to the phrase table 101. If the phrase table 101 has the phrase pair, the phrase table updating unit 116 updates the score corresponding to the phrase pair to the score calculated in step S303, and the procedure returns to the upper-level processing (S206).

(Step S305) The partial phrase pair generating unit 111 generates two phrase pairs smaller than the phrase pair intended to be generated, using, for example, the base measure P_{dac} or the probability distribution Pⁱ⁻¹ corresponding to the (i−1)-th translation corpus.

(Step S306) The symbol acquiring unit 109 acquires one symbol x, using the one or more pieces of symbol appearance frequency information.

(Step S307) The symbol appearance frequency information updating unit 110 increases the S appearance frequency information corresponding to the symbol x acquired by the symbol acquiring unit 109, by a predetermined value (typically “1”).

(Step S308) The new phrase pair generating unit 112 judges whether or not the symbol x acquired in step S306 is “BASE”. If the symbol x is “BASE”, the procedure advances to step S309, and, if not, the procedure advances to step S310.

(Step S309) The new phrase pair generating unit 112 generates a new phrase pair, using a prior probability of a phrase pair, and the procedure jumps to step S302.

(Step S310) The new phrase pair generating unit 112 judges whether or not the symbol x acquired in step S306 is “REG”. If the symbol x is “REG”, the procedure advances to step S311, and, if not, the procedure advances to step S315. Note that, if the symbol x is not “REG”, the symbol x is “INV”.

(Step S311) The new phrase pair generating unit 112 generates two smaller phrase pairs. It is assumed that the two phrase pairs are taken as a first phrase pair and a second phrase pair.

(Step S312) The phrase generation processing in FIG. 3 is performed on the first phrase pair generated in step S311.

(Step S313) The phrase generation processing in FIG. 3 is performed on the second phrase pair generated in step S311.

(Step S314) The new phrase pair generating unit 112 generates one phrase pair by integrating, in forward order, the two phrase pairs generated in steps S312 and S313, and the procedure jumps to step S302.

(Step S315) The new phrase pair generating unit 112 generates two smaller phrase pairs. It is assumed that the two phrase pairs are taken as a third phrase pair and a fourth phrase pair.

(Step S316) The phrase generation processing in FIG. 3 is performed on the third phrase pair generated in step S315.

(Step S317) The phrase generation processing in FIG. 3 is performed on the fourth phrase pair generated in step S315.

(Step S318) The new phrase pair generating unit 112 generates one phrase pair by integrating, in inverse order, the two phrase pairs generated in steps S316 and S317, and the procedure jumps to step S302.

Note that, in the flowcharts in FIGS. 2 and 3, the tree structure generation processing by the parsing unit 115 and the tree structure update processing by the tree updating unit 117 are preferably performed after step S304 and before returning to the upper-level processing. The tree structure that is to be updated is the tree structure of the i-th translation corpus among the translation corpuses.

Hereinafter, a specific operation of the bilingual phrase learning apparatus 1 in this embodiment will be described.

It is assumed that, in the symbol appearance frequency information storage unit 103, three pieces of symbol appearance frequency information respectively having the symbols “BASE”, “REG”, and “INV” and the appearance frequencies of these symbols are stored.

It is assumed that, in this situation, the translation corpus accepting unit 104 accepts a first translation corpus, and the first translation corpus is accumulated in the bilingual information storage unit 100 in association with 1.

Next, the phrase table initializing unit 106 generates initial information of the one or more scored phrase pairs, from the one or more pieces of bilingual information contained in the first translation corpus, and accumulates it in the phrase table 101 in association with 1.

Next, the generated phrase pair acquiring unit 107 acquires one pair of original and translated sentences, from the first translation corpus. Next, the generated phrase pair acquiring unit 107 subtracts the value (typically, the appearance frequency “1”) corresponding to the appearance of each of the one or more phrase pairs forming a tree structure of the acquired pair of original and translated sentences, from the score of the phrase pair in the phrase table 101.

Next, the generated phrase pair acquiring unit 107 intends to generate a phrase pair <f,e> corresponding to the pair of original and translated sentences, using a probability distribution P_{base}¹. The probability distribution P_{base}¹ is, for example, estimated in advance using the IBM MODEL 1 or the like and is held by the bilingual phrase learning apparatus 1.

If it is judged that no phrase pair has been generated in previous phrase pair generation processing, the partial phrase pair generating unit 111 performs processing as follows.

That is to say, the partial phrase pair generating unit 111 recursively generates two phrase pairs smaller than the phrase pair intended to be generated, using P_{base}¹. Then, the generated two smaller phrase pairs are combined to generate a new phrase pair. It is assumed that the probability of the phrase pair corresponding relationship <f,e> is expressed by Expression 3.

P( [symbol] f,e [symbol] ;θₜ¹ Expression 3

Furthermore, it is assumed that is a parameter of a translation model, and is a table expressing probability values of all <f,e>. In this case, θₜ¹ is estimated by the Pitman-Yor process in Expression 4.

θₜ¹˜PY(d¹,s¹,P_{base}¹) Expression 4

Next, the symbol acquiring unit 109 generates a symbol, according to the probability distribution Pₓ(x;θₓ) of the symbol, using the three pieces of symbol appearance frequency information. The symbol appearance frequency information updating unit 110 increases the S appearance frequency information corresponding to the symbol “x=REG” by 1.

Next, if the generated symbol x is “x=BASE”, the new phrase pair generating unit 112 directly generates a new phrase pair, from P_{base}¹. If the generated symbol x is “x=REG”, the new phrase pair generating unit 112 generates <f₁,e₁> and <f₂,e₂> from the phrase pair generation probability (Pₕᵢₑᵣ), and generates one phrase pair <f₁f₂,e₁e₂>. If the generated symbol x is “x=INV”, the new phrase pair generating unit 112 generates <f₁,e₁> and <f₂,e₂> from Pₕᵢₑᵣ, and generates one phrase pair <f₂f₁,e₁e₂> by arranging f₁ and f₂ in inverse order.

The phrase appearance frequency information updating unit 108 updates the phrase appearance frequency information of the newly generated phrase pair.

Furthermore, the score calculating unit 114 calculates a score of the phrase pair corresponding to the updated phrase appearance frequency information, using P_{base}¹.

Next, the phrase table updating unit 116 updates the phrase table.

Next, the parsing unit 115 acquires a new tree structure such that the tree structure has the largest score, using the score calculated by the score calculating unit 114. The tree updating unit 117 accumulates the acquired tree structure in the translation corpus, and updates the old tree structure to the new tree structure.

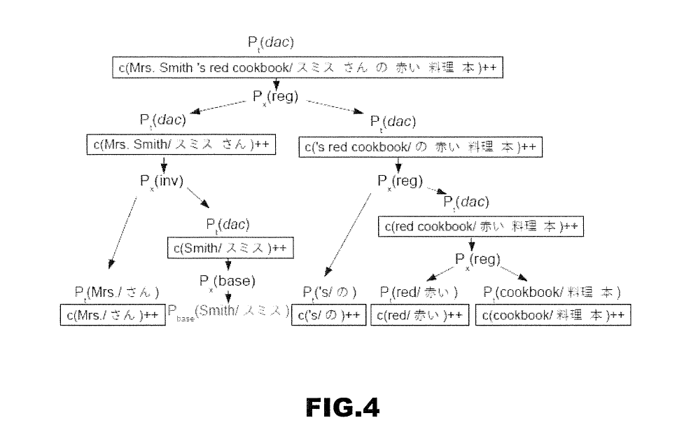

With the above-described processing, for example, phrase pairs having a granularity with multiple levels can be learned from the phrase pair “Mrs. Smith's red cookbook [symbol] [symbol] ” as shown in FIG. 4. FIG. 4 shows an example of a tree structure forming bilingual information.

Furthermore, the phrase table 101 is constructed in this specific example, for example, as follows.

As a feature of the phrase table, conditional probabilities Pₜ(f|e) and Pₜ(e|f), a lexical weighting probability, a phrase penalty, and the like are used. In this example, the conditional probability is calculated using a model probability Pₜ. That is to say, the conditional probability is calculated using Expressions 5 and 6. For example, the score calculating unit 114 calculates a score by multiplying each feature in the phrase table by a predetermined weight and totaling the obtained values. The lexical weighting probability can be calculated using words forming phrases. Such calculation is a known art (P. Koehn, F. J. Och, and D. Marcu. Statistical phrase-based translation. In Proc. NAACL, pp. 48-54, 2003). The phrase penalty is, for example, “1” for all phrases.

$$\begin{matrix}{P}_{t} ( f \vert e ) = {P}_{t} ( < e , f > ) / {\sum }_{\{ \tilde{f} : c ( < e , \tilde{f} > ) \geq 1 \}} {P}_{t} ( < e , \tilde{f} > ) & Expression 5 \\ {P}_{t} ( e \vert f ) = {P}_{t} ( < e , f > ) / {\sum }_{\{ \tilde{e} : c ( < \tilde{e} , f > ) \geq 1 \}} {P}_{t} ( < \tilde{e} , f > ) . & Expression 6\end{matrix}$$

Note that, in Expression 5, the term Σ refers to Pₜ(e), where phrase pairs having a frequency of 1 or more and having the same e are enumerated among all <e,f> and probability values thereof are totaled. Note that f˜ (˜ is positioned directly above f) refers to f forming phrase pairs having the same e among all <e,f>. In Expression 6, the term Σ refers to Pₜ(f), where phrase pairs having a frequency of 1 or more and having the same f are enumerated among all <e,f> and probability values thereof are totaled. Note that e˜ (˜ is positioned directly above e) refers to e forming phrase pairs having the same f among all <e,f>. Furthermore, c(<e,f˜>) refers to a frequency of <e,f˜>, and c(<e˜,f>) refers to a frequency of <e˜,f>.

The phrase table updating unit 116 adds only a phrase pair p that appears once or more in the sample, to the phrase table 101. Furthermore, the phrase table updating unit 116 adds two features. A first feature is a joint probability Pₜ(<f,e>) of a phrase pair according to a model. A second feature is an average posterior probability of each span containing a certain phrase pair <f,e>, based on the span posterior probability calculated according to the inside-outside algorithm. The span probability is high in a phrase pair that frequently appears, or a phrase pair formed based on a phrase pair that frequently appears, and, thus, it is useful for determining the reliability of the phrase pair. The phrase extraction based on this model probability is referred to as MOD. The span probability can be calculated by the ITG chart parser.

The above-described processing is performed on all pairs of original and translated sentences contained in the first translation corpus.

Next, it is assumed that the translation corpus accepting unit 104 accepts a second translation corpus, and the second translation corpus is accumulated in the bilingual information storage unit 100 in association with 2.

Next, it is assumed that the phrase table initializing unit 106 generates initial information of the one or more scored phrase pairs, from the one or more pieces of bilingual information contained in the second translation corpus, and accumulates it in the phrase table 101 in association with 2.

Next, the generated phrase pair acquiring unit 107 acquires one pair of original and translated sentences, from the second translation corpus. Next, the generated phrase pair acquiring unit 107 subtracts the value (typically, the appearance frequency “1”) corresponding to the appearance of each of the one or more phrase pairs forming a tree structure of the acquired pair of original and translated sentences, from the score of the phrase pair in the phrase table 101. Next, the generated phrase pair acquiring unit 107 intends to generate a phrase pair <f,e> corresponding to the pair of original and translated sentences, using a probability distribution P¹. The probability distribution P¹ is a probability distribution acquired in the above-described processing performed on the first translation corpus.

If it is judged that no phrase pair has been generated in previous phrase pair generation processing, the partial phrase pair generating unit 111 performs processing as follows.

That is to say, the partial phrase pair generating unit 111 recursively generates two phrase pairs smaller than the phrase pair intended to be generated, using P¹. Then, the generated two smaller phrase pairs are combined to generate a new phrase pair. It is assumed that the second translation model (θₜ²) is estimated by the Pitman-Yor process in Expression 7.

θₜ²˜PY(d²,s²,P¹) Expression 7

Next, the symbol acquiring unit 109 generates a symbol, according to the probability distribution Pₓ(x;θₓ) of the symbol, using the three pieces of symbol appearance frequency information. The symbol appearance frequency information updating unit 110 increases the S appearance frequency information corresponding to the symbol “x=REG” by 1.

Next, if the generated symbol x is “x=BASE”, the new phrase pair generating unit 112 directly generates a new phrase pair, from P¹. If the generated symbol x is “x=REG”, the new phrase pair generating unit 112 generates <f₁,e₁> and <f₂,e₂> from the phrase pair generation probability (Pₕᵢₑᵣ), and generates one phrase pair <f₁f₂,e₁e₂>. If the generated symbol x is “x=INV”, the new phrase pair generating unit 112 generates <f₁,e₁> and <f₂,e₂> from Pₕᵢₑᵣ, and generates one phrase pair <f₂f₁,e₁e₂> by arranging f₁ and f₂ in inverse order.

The phrase appearance frequency information updating unit 108 updates the phrase appearance frequency information of the newly generated phrase pair. Note that this phrase appearance frequency information is phrase appearance frequency information corresponding to the second translation corpus.

Furthermore, the score calculating unit 114 calculates a score of the phrase pair corresponding to the updated phrase appearance frequency information, using P¹.

Next, the phrase table updating unit 116 updates the phrase table corresponding to the second translation corpus.

Next, the parsing unit 115 acquires a new tree structure such that the tree structure has the largest score, using the score calculated by the score calculating unit 114. The tree updating unit 117 accumulates the acquired tree structure in the translation corpus, and updates the old tree structure to the new tree structure. Note that this tree structure is a tree structure corresponding to the second translation corpus.

The above-described processing is performed on all pairs of original and translated sentences contained in the second translation corpus. Then, one or more scored phrase pairs associated with 2 are accumulated in the phrase table 101.

It is assumed that the above-described processing is performed also on a third and subsequent translation corpuses. In the phrase table 101, a large number of scored phrase pairs corresponding to each of the first to (j−1)-th translation corpuses are stored. For example, it is assumed that the probability distribution of a large number of phrase pairs in the (j−1)-th group is P^{j-1}. Note that j is a natural number of 3 or more.

It is assumed that, in this situation, the translation corpus accepting unit 104 accepts a j-th translation corpus, and the j-th translation corpus is accumulated in the bilingual information storage unit 100 in association with j.

Next, the phrase table initializing unit 106 generates initial information of the one or more scored phrase pairs, from the one or more pieces of bilingual information contained in the j-th translation corpus, and accumulates it in the phrase table 101 in association with j.

Next, the generated phrase pair acquiring unit 107 acquires one pair of original and translated sentences, from the translation corpus. Next, the generated phrase pair acquiring unit 107 subtracts the value (typically, the appearance frequency “1”) corresponding to the appearance of each of the one or more phrase pairs forming a tree structure of the acquired pair of original and translated sentences, from the score of the phrase pair in the phrase table 101. Next, the generated phrase pair acquiring unit 107 intends to generate a phrase pair <f,e> corresponding to the pair of original and translated sentences, using a probability distribution P^{j-1} of the (j−1)-th group of phrase pairs. The probability distribution P^{j-1} is a probability distribution acquired in the processing performed on the (j−1)-th translation corpus.

If it is judged that no phrase pair has been generated in previous phrase pair generation processing, the partial phrase pair generating unit 111 performs processing as follows.

That is to say, the partial phrase pair generating unit 111 recursively generates two phrase pairs smaller than the phrase pair intended to be generated, using the probability distribution P^{j-1}. Then, the generated two smaller phrase pairs are combined to generate a new phrase pair. Note that θₜ^{j} is estimated by the Pitman-Yor process in Expression 8.

θₜ^{j}˜PY(d^{j},s^{j},P^{j-1}) Expression 8

Next, the symbol acquiring unit 109 generates a symbol, according to the probability distribution Pₓ(x;θₓ) of the symbol, using the three pieces of symbol appearance frequency information. The symbol appearance frequency information updating unit 110 increases the S appearance frequency information corresponding to the symbol “x=REG” by 1.

Next, if the generated symbol x is “x=BASE”, the new phrase pair generating unit 112 directly generates a new phrase pair, from P¹. If the generated symbol x is “x=REG”, the new phrase pair generating unit 112 generates <f₁,e₁> and <f₂,e₂> from the phrase pair generation probability (Pₕᵢₑᵣ), and generates one phrase pair <f₁f₂,e₁e₂>. If the generated symbol x is “x=INV”, the new phrase pair generating unit 112 generates <f₁,e₁> and <f₂,e₂> from Pₕᵢₑᵣ, and generates one phrase pair <f₂f₁,e₁e₂> by arranging f₁ and f₂ in inverse order.

The phrase appearance frequency information updating unit 108 updates the phrase appearance frequency information of the newly generated phrase pair. Note that this phrase appearance frequency information is phrase appearance frequency information corresponding to the j-th translation corpus.

Furthermore, the score calculating unit 114 calculates a score of the phrase pair corresponding to the updated phrase appearance frequency information, using P^{j-1}.

Next, the phrase table updating unit 116 updates the phrase table corresponding to the j-th translation corpus.

Next, the parsing unit 115 acquires a new tree structure such that the tree structure has the largest score, using the score calculated by the score calculating unit 114. The tree updating unit 117 accumulates the acquired tree structure in the translation corpus, and updates the old tree structure to the new tree structure. Note that this tree structure is a tree structure corresponding to the j-th translation corpus.

The above-described processing is performed on all pairs of original and translated sentences contained in the j-th translation corpus. Then, one or more scored phrase pairs associated with j are accumulated in the phrase table 101.

As described above, according to this embodiment, a translation model generated from an added translation corpus can be integrated to an original translation model, and, thus, a translation model can be easily enhanced in a stepwise manner.

Furthermore, according to this embodiment, the level of precision of machine translation using a phrase table generated by the bilingual phrase learning apparatus 1 can be maintained, and the size of the phrase table can be significantly reduced. That is to say, according to this embodiment, a large number of proper phrase pairs can be learned.

The processing in this embodiment may be realized using software. The software may be distributed by software download or the like. Furthermore, the software may be distributed in a form where the software is stored in a storage medium such as a CD-ROM. Note that the same is applied to other embodiments described in this specification. The software that realizes the information processing apparatus in this embodiment may be the following sort of program. Specifically, this program is a program for causing a computer-accessible storage medium to have: a bilingual information storage unit in which N translation corpuses (N is a natural number of 2 or more) each having one or more pieces of bilingual information, each of which has a pair of original and translated sentences and a tree structure of the pair of original and translated sentences, can be stored; a phrase table in which one or more scored phrase pairs each having a phrase pair, which is a pair of a first language phrase having one or more words in a first language and a second language phrase having one or more words in a second language, and a score, which is information regarding an appearance probability of the phrase pair, can be stored; a phrase appearance frequency information storage unit in which one or more pieces of phrase appearance frequency information each having a phrase pair and F appearance frequency information, which is information regarding an appearance frequency of the phrase pair, can be stored for each translation corpus; and a symbol appearance frequency information storage unit in which one or more pieces of symbol appearance frequency information each having a symbol for identifying a method for generating a new phrase pair and S appearance frequency information, which is information regarding an appearance frequency of the symbol, can be stored; and causing a computer to function as: a generated phrase pair acquiring unit that acquires, for each translation corpus, a phrase pair having a first language phrase and a second language phrase, using the one or more pieces of phrase appearance frequency information; a phrase appearance frequency information updating unit that, in a case where a phrase pair has been acquired, increases the F appearance frequency information corresponding to the phrase pair, by a predetermined value; a symbol acquiring unit that, in a case where a phrase pair has not been acquired, acquires one symbol, using the one or more pieces of symbol appearance frequency information; a symbol appearance frequency information updating unit that increases the S appearance frequency information corresponding to the symbol acquired by the symbol acquiring unit, by a predetermined value; a partial phrase pair generating unit that, in a case where a phrase pair has not been acquired, generates two phrase pairs smaller than the phrase pair intended to be acquired; a new phrase pair generating unit that performs one of first processing, second processing, and third processing, according to the symbol acquired by the symbol acquiring unit, the first processing being processing that generates a new phrase pair, the second processing being processing that generates two smaller phrase pairs, and generates one phrase pair having a new first language phrase obtained by integrating, in forward order, two first language phrases forming the generated two phrase pairs and a new second language phrase obtained by integrating, in forward order, two second language phrases forming the two phrase pairs, using the one or more pieces of phrase appearance frequency information, and third processing being processing that generates two smaller phrase pairs, and generates one phrase pair having a new first language phrase obtained by integrating, in forward order, two first language phrases forming the generated two phrase pairs and a new second language phrase obtained by integrating, in inverse order, two second language phrases forming the two phrase pairs, using the one or more pieces of phrase appearance frequency information; a control unit that gives an instruction to recursively perform the processing by the phrase appearance frequency information updating unit, the symbol acquiring unit, the symbol appearance frequency information updating unit, the partial phrase pair generating unit, and the new phrase pair generating unit, on the phrase pair generated by the new phrase pair generating unit; a score calculating unit that calculates a score of each phrase pair in the phrase table, using the one or more pieces of phrase appearance frequency information stored in the phrase appearance frequency information storage unit; and a phrase table updating unit that accumulates the score calculated by the score calculating unit, in association with the corresponding phrase pair; wherein the program causes the computer to operate such that, in a case of calculating a score of each phrase pair acquired from a j-th translation corpus (2≦j≦N), the score calculating unit calculates a score of each phrase pair corresponding to the j-th translation corpus, using the one or more pieces of phrase appearance frequency information corresponding to a (j−1)-th translation corpus.

It is preferable that one or more translation corpuses are stored in the bilingual information storage unit, and an upper-level program causes the computer to further function as: a translation corpus accepting unit that accepts a translation corpus; and a translation corpus accumulating unit that accumulates the translation corpus accepted by the translation corpus accepting unit, in the bilingual information storage unit; and causes the computer to operate such that, after the translation corpus accumulating unit accumulates the accepted translation corpus in the bilingual information storage unit, the control unit gives an instruction to perform the processing by the generated phrase pair acquiring unit, the phrase appearance frequency information updating unit, the symbol acquiring unit, the symbol appearance frequency information updating unit, the partial phrase pair generating unit, and the new phrase pair generating unit, on the translation corpus, and, in a case of calculating a score of each phrase pair acquired from the translation corpus accepted by the translation corpus accepting unit, the score calculating unit calculates a score of each phrase pair corresponding to the translation corpus accepted by the translation corpus accepting unit, using the one or more pieces of phrase appearance frequency information corresponding to one translation corpus among the one or more translation corpuses stored in the bilingual information storage unit before the translation corpus accumulating unit accumulates the translation corpus.

### Embodiment 2

In this embodiment, a bilingual phrase learning apparatus will be described that independently performs learning in multiple domains, replaces a prior probability of each domain with a model obtained in another domain, and hierarchically integrates multiple models.

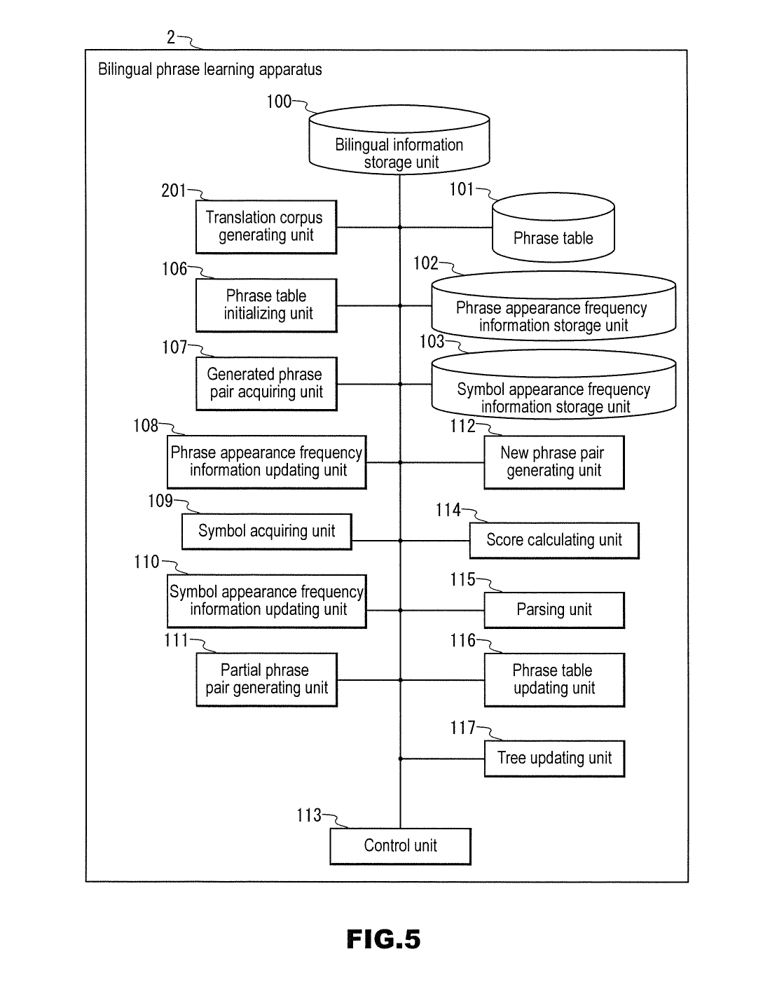

FIG. 5 is a block diagram of a bilingual phrase learning apparatus 2 in this embodiment. As shown in FIG. 5, the bilingual phrase learning apparatus 2 is different from the bilingual phrase learning apparatus 1 in that a translation corpus generating unit 201 is provided but the translation corpus accepting unit 104 and the translation corpus accumulating unit 105 are not provided.

The translation corpus generating unit 201 splits two or more pairs of original and translated sentences into N groups, and accumulates N translation corpuses generated by acquiring tree structures of pairs of original and translated sentences from the pairs of original and translated sentences in the respective groups, in the bilingual information storage unit 100. N is a natural number of 2, 3, or more. There is no limitation on the splitting method. If original and translated sentences are provided with class identifiers for identifying classes, the translation corpus generating unit 201 may split two or more pairs of original and translated sentences into N groups, using the class identifiers. The translation corpus generating unit 201 may split two or more pairs of original and translated sentences into N groups such that groups include the same number of pairs of original and translated sentences.

The translation corpus generating unit 201 may be realized typically by an MPU, a memory, or the like. Typically, the processing procedure of the translation corpus generating unit 201 is realized by software, and the software is stored in a storage medium such as a ROM. Note that the processing procedure of the translation corpus generating unit 201 may be realized also by hardware (a dedicated circuit).

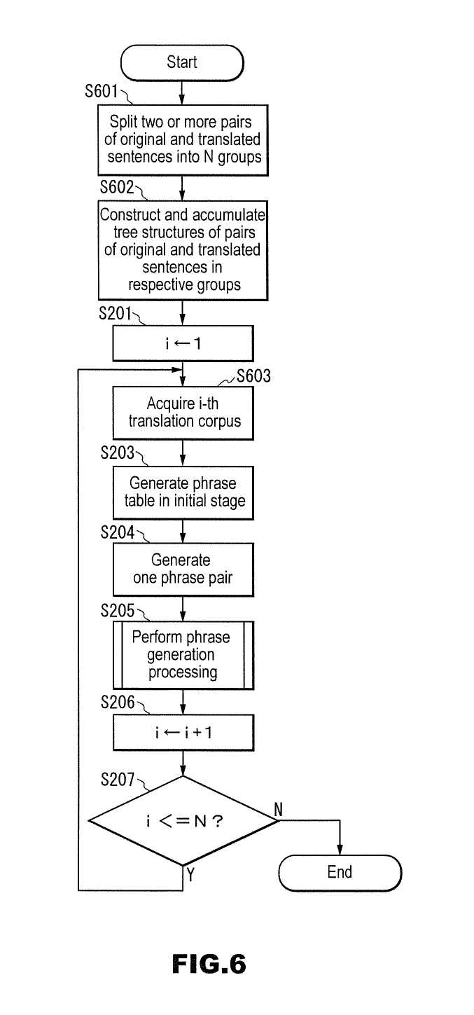

Next, an operation of the bilingual phrase learning apparatus 2 will be described with reference to the flowchart in FIG. 6. In the flowchart in FIG. 6, a description of the same steps as in the flowchart in FIG. 2 has been omitted.

(Step S601) The translation corpus generating unit 201 splits two or more pairs of original and translated sentences stored in the bilingual information storage unit 100, into N groups. Each group has a translation corpus having one or more pairs of original and translated sentences.

(Step S602) The translation corpus generating unit 201 constructs a tree structure of each of one or more pairs of original and translated sentences in each group, and accumulates it in the bilingual information storage unit 100. With this processing, final translation corpuses of the N groups are stored in the bilingual information storage unit 100. Each of the translation corpuses has one or more pieces of bilingual information, each of which has a pair of original and translated sentences and a tree structure of the pair of original and translated sentences.

(Step S603) The phrase table initializing unit 106 acquires an i-th translation corpus, from the bilingual information storage unit 100. The procedure advances to step S203.

In the flowchart in FIG. 6, in the case of constructing a phrase table corresponding to the translation corpus of the j-th group, typically, a phrase table corresponding to the translation corpus of the (j−1)-th group is used. However, in the case of constructing a phrase table corresponding to the translation corpus of the j-th group, a phrase table that has been already acquired and corresponds to another group (e.g., a phrase table corresponding to the translation corpus of the third group) may be used.

As described above, according to this embodiment, a translation model generated from an added translation corpus can be integrated to an original translation model, and, thus, a translation model can be easily enhanced in a stepwise manner.

As described above, according to this embodiment, bilingual data is split, for example, into each domain, and local models are trained in the respective domains, and, thus, parallel processing can be easily performed. According to this embodiment, in the case of combining statistical models obtained by training, their weights do not have to be calculated again, and the translation model can be easily enhanced.

The bilingual phrase learning apparatus 1 and 2 described in the foregoing embodiments have the effects as follows. That is to say, according to the bilingual phrase learning apparatus 1 and the bilingual phrase learning apparatus 2, in the case of newly adding bilingual data to an existing large-scale bilingual data that is being newly updated on a daily basis, the cost of retraining can be significantly reduced. Especially in the case of performing processing in a new domain or the like such as patent data, the bilingual phrase learning apparatus 1 and the bilingual phrase learning apparatus 2 can learn an existing statistical model as a prior probability, and easily estimate parameters of a new model. The bilingual phrase learning apparatus 1 and the bilingual phrase learning apparatus 2 can newly add bilingual data each time a new expression appears in a daily conversation or the like, hold a general model as a prior probability, and generate a model for that added amount.

The software that realizes the information processing apparatus in this embodiment may be the following sort of program. Specifically, this program is a program for causing a computer-accessible storage medium to have: a bilingual information storage unit in which N translation corpuses (N is a natural number of 2 or more) each having one or more pieces of bilingual information, each of which has a pair of original and translated sentences and a tree structure of the pair of original and translated sentences, can be stored; a phrase table in which one or more scored phrase pairs each having a phrase pair, which is a pair of a first language phrase having one or more words in a first language and a second language phrase having one or more words in a second language, and a score, which is information regarding an appearance probability of the phrase pair, can be stored; a phrase appearance frequency information storage unit in which one or more pieces of phrase appearance frequency information each having a phrase pair and F appearance frequency information, which is information regarding an appearance frequency of the phrase pair, can be stored for each translation corpus; and a symbol appearance frequency information storage unit in which one or more pieces of symbol appearance frequency information each having a symbol for identifying a method for generating a new phrase pair and S appearance frequency information, which is information regarding an appearance frequency of the symbol, can be stored; and causing a computer to function as: a generated phrase pair acquiring unit that acquires, for each translation corpus, a phrase pair having a first language phrase and a second language phrase, using the one or more pieces of phrase appearance frequency information; a phrase appearance frequency information updating unit that, in a case where a phrase pair has been acquired, increases the F appearance frequency information corresponding to the phrase pair, by a predetermined value; a symbol acquiring unit that, in a case where a phrase pair has not been acquired, acquires one symbol, using the one or more pieces of symbol appearance frequency information; a symbol appearance frequency information updating unit that increases the S appearance frequency information corresponding to the symbol acquired by the symbol acquiring unit, by a predetermined value; a partial phrase pair generating unit that, in a case where a phrase pair has not been acquired, generates two phrase pairs smaller than the phrase pair intended to be acquired; a new phrase pair generating unit that performs one of first processing, second processing, and third processing, according to the symbol acquired by the symbol acquiring unit, the first processing being processing that generates a new phrase pair, the second processing being processing that generates two smaller phrase pairs, and generates one phrase pair having a new first language phrase obtained by integrating, in forward order, two first language phrases forming the generated two phrase pairs and a new second language phrase obtained by integrating, in forward order, two second language phrases forming the two phrase pairs, using the one or more pieces of phrase appearance frequency information, and third processing being processing that generates two smaller phrase pairs, and generates one phrase pair having a new first language phrase obtained by integrating, in forward order, two first language phrases forming the generated two phrase pairs and a new second language phrase obtained by integrating, in inverse order, two second language phrases forming the two phrase pairs, using the one or more pieces of phrase appearance frequency information; a control unit that gives an instruction to recursively perform the processing by the phrase appearance frequency information updating unit, the symbol acquiring unit, the symbol appearance frequency information updating unit, the partial phrase pair generating unit, and the new phrase pair generating unit, on the phrase pair generated by the new phrase pair generating unit; a score calculating unit that calculates a score of each phrase pair in the phrase table, using the one or more pieces of phrase appearance frequency information stored in the phrase appearance frequency information storage unit; and a phrase table updating unit that accumulates the score calculated by the score calculating unit, in association with the corresponding phrase pair; wherein the program causes the computer to operate such that, in a case of calculating a score of each phrase pair acquired from a j-th translation corpus (2≦j≦N), the score calculating unit calculates a score of each phrase pair corresponding to the j-th translation corpus, using the one or more pieces of phrase appearance frequency information corresponding to a (j−1)-th translation corpus.

It is preferable that an upper-level program causes the computer to further function as a translation corpus generating unit that splits two or more pairs of original and translated sentences into N groups, and accumulates N translation corpuses generated by acquiring tree structures of pairs of original and translated sentences from the pairs of original and translated sentences in the respective groups, in the bilingual information storage unit, and causes the computer to operate such that, in a case of calculating a score of each phrase pair acquired from one translation corpus, the score calculating unit calculates a score of each phrase pair corresponding to the one translation corpus, using the one or more pieces of phrase appearance frequency information corresponding to a translation corpus different from the one translation corpus.

### Embodiment 3

In this embodiment, a statistical machine translation apparatus 3 will be described that uses the phrase table 101 learned by the bilingual phrase learning apparatus 1 or the bilingual phrase learning apparatus 2.

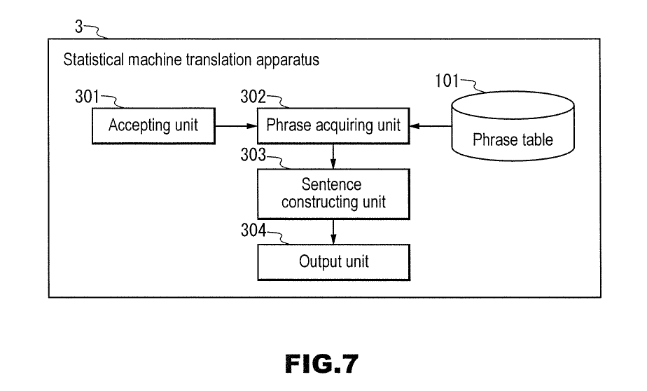

FIG. 7 is a block diagram of the statistical machine translation apparatus 3 in this embodiment. The statistical machine translation apparatus 3 includes the phrase table 101, an accepting unit 301, a phrase acquiring unit 302, a sentence constructing unit 303, and an output unit 304.

The phrase table 101 is a phrase table learned by the bilingual phrase learning apparatus 1 or the bilingual phrase learning apparatus 2.

The accepting unit 301 accepts a sentence in a first language having one or more words. The accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory, and the like. The sentence in a first language may be input through any part such as a keyboard, a mouse, a menu screen, or the like. The accepting unit 301 may be realized by a device driver for an input part such as a keyboard, control software for a menu screen, or the like.

The phrase acquiring unit 302 extracts one or more phrases from the sentence accepted by the accepting unit 301, and acquires one or more phrases in a second language from the phrase table 101, using a score in the phrase table 101. The processing by the phrase acquiring unit 302 is a known art.

The sentence constructing unit 303 constructs a sentence in the second language, from the one or more phrases acquired by the phrase acquiring unit 302. The processing by the sentence constructing unit 303 is a known art.

The output unit 304 outputs the sentence constructed by the sentence constructing unit 303. The output is a concept that encompasses display on a display screen, projection using a projector, printing in a printer, output of a sound, transmission to an external apparatus, accumulation in a storage medium, delivery of a processing result to another processing apparatus or another program, and the like.

The phrase acquiring unit 302 and the sentence constructing unit 303 may be realized typically by an MPU, a memory, or the like. Typically, the processing procedure of the phrase acquiring unit 302 and the like is realized by software, and the software is stored in a storage medium such as a ROM. Note that the processing procedure of the phrase acquiring unit 302 and the like may be realized also by hardware (a dedicated circuit).

The output unit 304 may be considered to include or not to include an output device such as a display screen or a loudspeaker. The output unit 304 may be realized, for example, by driver software for an output device, a combination of driver software for an output device and the output device, or the like.

Furthermore, an operation of the statistical machine translation apparatus 3 can be realized by performing known phrase-based statistical machine translation processing, and, thus, a detailed description thereof has been omitted.

As described above, according to this embodiment, precise machine translation can be realized using hierarchically integrated phrase tables.

Hereinafter, experimental results of the bilingual phrase learning apparatus 1 and the bilingual phrase learning apparatus 2 will be described.

### Experiment

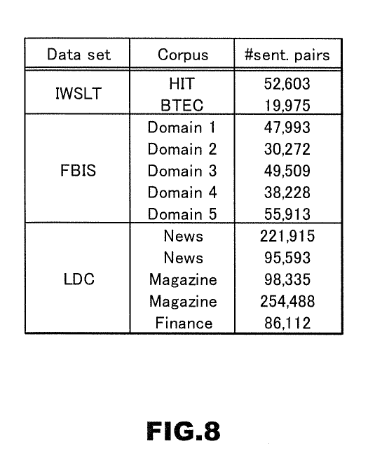

FIG. 8 shows information on data sets used in the experiment. In this experiment, tasks of Chinese-English translation (translation from Chinese to English) were used. In this experiment, three data sets having different sizes shown in FIG. 8 were used. In FIG. 8, “Data set” is the name of a data set, “Corpus” is the name of a corpus in the data set, and “#sent.pairs” is the number of pairs of original and translated sentences.

In FIG. 8, the data set “IWSLT” is a data set used in IWSLT2012 OLYMPICS, and consists of two training sets (HIT corpus and BTEC corpus). The HIT corpus is closely related to Beijing Olympics in 2008. The BTEC corpus is a multi-language audio corpus containing tourism-related sentences.

Furthermore, in FIG. 8, the data set “FBIS” is a collection of news articles, and does not have information on the domain (field). Thus, a latent dirichlet allocation (LDA) tool called PLDA (see http://code.google.com/p/plda/) was used to split the entire corpus into five domains. In each of the five domains, a source side (first language side) and a target side (second language side) are integrated into a single sentence (Zhiyuan Liu, Yuzhou Zhang, Edward Y Chang, and Maosong Sun. 2011. Plda+: Parallel latent dirichlet allocation with data placement and pipeline processing. ACM Transactions on Intelligent Systems and Technology (TIST), 2(3): 1-18).

Furthermore, in FIG. 8, the data set “LDC” includes various domains such as news, magazine, and finance, and consists of five corpuses acquired from LDC.

Furthermore, in this experiment, the following five phrase pair extraction methods were used, and the bilingual phrase learning apparatus 1 and the bilingual phrase learning apparatus 2 were evaluated. Note that the method of the bilingual phrase learning apparatus 1 and the bilingual phrase learning apparatus 2 is referred to as “Hier-combin”.

### (1) GIZA-Linear

In this method, phrase pairs are extracted in each domain by GIZA++ (Franz Josef Och and Hermann Ney. 2003. A systematic comparison of various statistical alignment models. Computational linguistics, 29 (1): 19-51) and the “grow-diag-final-and” method with a maximum length of 7. In this method, phrase tables constructed from various domains are linearly combined by evening out the feature amounts.

### (2) Pialign-Linear

This method is similar to GIZA-linear, but is different from GIZA-linear in that the phrase ITG method is used by using the pialign tool kit (Graham Neubig, Taro Watanabe, Eiichiro Sumita, Shinsuke Mori, and Tatsuya Kawahara. 2011. An unsupervised model for joint phrase alignment and extraction. In Proceedings of the 49th Annual Meeting of the Association for Computational Linguistics: Human Language Technologies, pages 632-641, Portland, Oreg., USA, June. Association for Computational Linguistics). Also in this method, the extracted phrase pairs are linearly combined by evening out the feature amounts.

### (3) GIZA-Batch

In this method, a data set is not split into domains, but is treated as one corpus. In this method, a heuristic GIZA-based phrase extraction method, which is similar to GIZA-linear, is used.

### (4) Pialign-Batch

In this method, a single model is estimated as a single merged corpus as in GIZA-batch. Since Pialign cannot handle large-scale data, it was not used in the experiment on the maximum LDC data set.

### (5) Pialign-Adaptive

In this method, alignments and phrase pairs are extracted using a similar method to that in Pialign-batch. In this method, a translation probability is estimated using an adaptive approach using monolingual topic information.

Furthermore, in the method “Hier-combin” of the bilingual phrase learning apparatus 1 and the bilingual phrase learning apparatus 2, a similar method to that in “Pialign-linear” was used to extract phrase pairs. In the integrating processing of phrase tables, a translation probability of each phrase pair is estimated by “Hier-combin”. Other features are linearly combined by evening out the feature amounts. “Pialign” uses default parameters. The parameter “samps” is set to 5. Note that “5” means that five samples are generated for one pair of original and translated sentences.

Furthermore, in this experiment, batch-MIRA (Colin Cherry and George Foster. 2012. Batch tuning strategies for statistical machine translation. In Proceedings of the 2012 Conference of the North American Chapter of the Association for Computational Linguistics: Human Language Technologies, pages 427-436, Montreal, Canada, June. Association for Computational Linguistics) was used to tune the weight of each feature amount. In order to evaluate the translation quality, case-insensitive BLEU-4 metric (Kishore Papineni, Salim Roukos, Todd Ward, and Wei Jing Zhu. 2002. Bleu: a method for automatic evaluation of machine translation. In Proceedings of 40th Annual Meeting of the Association for Computational Linguistics, pages 311-318, Philadelphia, Pa., USA, July. Association for Computational Linguistics) was used.

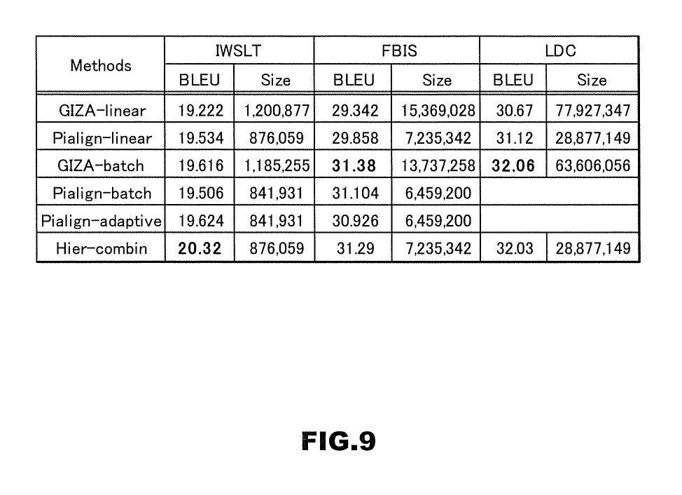

FIG. 9 shows results of the experiment performed in the above-described environments. In FIG. 9, “BLEU” is the evaluation value of the translation quality, and “Size” is the number of phrase pairs. It is seen from FIG. 9 that the result of “Hier-combin” is better than that of “Pialign-linear”. Note that “Hier-combin” and “Pialign-linear” are different from each other only in their translation probabilities, and have the same phrase pairs and the same number of phrase pairs.

Furthermore, the performance of “Pialign-adaptive” is better than the performance of “Pialign-linear”, but is worse than the performance of “Hier-combin”. This proves that the adaptive approach using monolingual topic information is useful in tasks. However, “Hier-combin” using the hierarchical Pitman-Yor process can estimate a more accurate translation probability based on all data from various domains. That is to say, it is seen from FIG. 9 that “Hier-combin” is evaluated to have a better translation quality than the other methods, on various data sets with a relatively smaller number of phrase pairs.

More specifically, it is seen from FIG. 9 that “Hier-combin” realizes a competitive performance using a much smaller phrase table than that of “GIZA-batch”. For the respective data sets, the numbers of phrase pairs generated by the “Hier-combin” method are 73.9%, 52.7%, and 45.4% of those by “GIZA-batch”, that is, are much smaller than those by “GIZA-batch”.

In the IWLST2012 data set, there was a large difference between the HIT corpus and the BTEC corpus, and it was seen that the BLEU value of the “Hier-combin” method was higher by 0.814 than that of the “Pialign-batch” method. Meanwhile, in the FBIS data set, the data was artificially split into sub domains, and the allocation standards were not clear, and, thus, the BLEU value of the “Hier-combin” method was lower by 0.09 than that of the “GIZA-batch” method.

Furthermore, according to “Hier-combin”, phrase pairs can be independently acquired from multiple domains. Thus, according to “Hier-combin”, processing can be performed by different machines in the respective domains, and parallel processing can be performed.

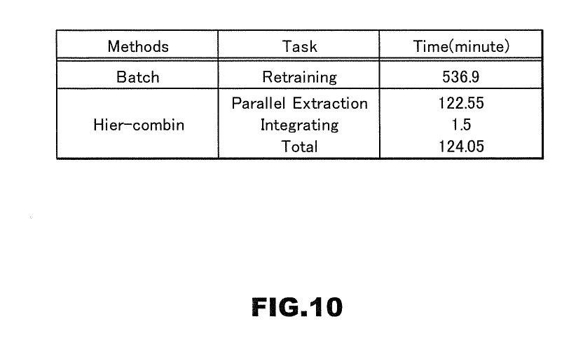

Furthermore, FIG. 10 shows the times that were necessary to extract alignments and phrase pairs in the case of using the “FBIS” data set. In FIG. 10, “Batch” is a batch-based ITGs sampling method (“pialign-batch”). FIG. 10 shows experimental results using a 2.7-GHz E5-2680 CPU and a 128-GByte memory. In FIG. 10, “Parallel Extraction” is the time that was necessary in the case of performing parallel processing, “Integrating” is the time that was necessary to perform integration processing, and “Total” is the total of the parallel processing time and the integration processing time.

In FIG. 10, a comparison between “Hier-combin” and “pialign-batch” shows that the time that was necessary for training in “Hier-combin” was much shorter than one-fourth of that in “pialign-batch”. Meanwhile, it is seen from FIG. 9 that the BLEU value of “Hier-combin” was slightly higher than that of “pialign-batch”.

The “Hier-combin” method that performs hierarchical combining uses the characteristics of the hierarchical Pitman-Yor process. The “Hier-combin” method has a better smoothing effect. Use of the “Hier-combin” method makes it possible to generate simple phrase tables based on all data from various domains with more accurate probabilities in a stepwise manner. Although phrase pairs are extracted in traditional SMT in the batch base, the “Hier-combin” method can extract phrase pairs very efficiently, and, is not inferior to the traditional SMT method in terms of the translation precision.

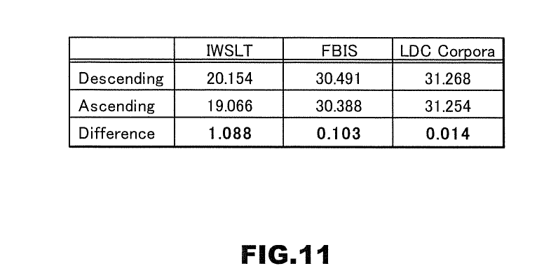

FIG. 11 shows BLEU values in the cases of using different combining methods on three data sets in the “Hier-combin” method. FIG. 11 shows results sorted using the similarity as a key, where “Descending” refers to the descending order and “Ascending” refers to the ascending order. The similarity of data was calculated using a perplexity indicator using a 5-gram language model.

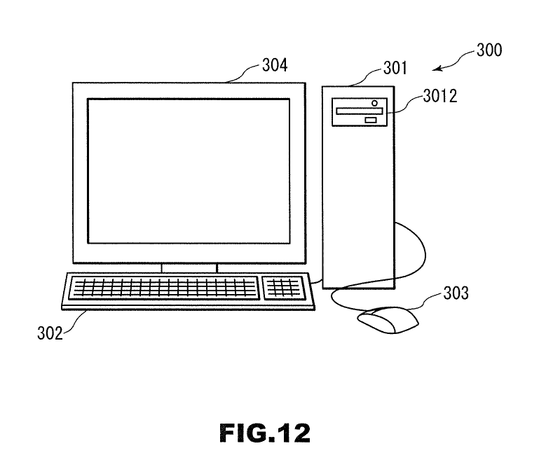

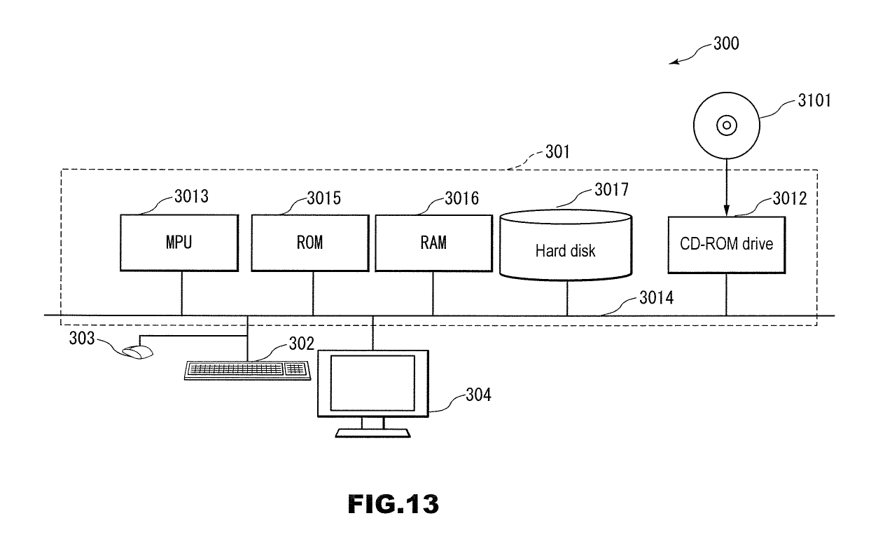

FIG. 12 shows the external appearance of a computer that executes the programs described in this specification to realize the bilingual phrase learning apparatus and the like in the foregoing various embodiments. The foregoing embodiments may be realized using computer hardware and a computer program executed thereon. FIG. 12 is a schematic view of a computer system 300. FIG. 13 is a block diagram of the computer system 300.

In FIG. 12, the computer system 300 includes a computer 301 including a CD-ROM drive, a keyboard 302, a mouse 303, and a monitor 304.

In FIG. 13, the computer 301 includes not only the CD-ROM drive 3012, but also an MPU 3013, a bus 3014 connected to the MPU 3013 and the CD-ROM drive 3012, a ROM 3015 in which a program such as a boot up program is to be stored, a RAM 3016 that is connected to the MPU 3013 and is a memory in which a command of an application program is temporarily stored and a temporary storage area is to be provided, and a hard disk 3017 in which an application program, a system program, and data are to be stored. Although not shown, the computer 301 may further include a network card that provides connection to a LAN.

The program for causing the computer system 300 to execute the functions of the bilingual phrase learning apparatus and the like in the foregoing embodiments may be stored in a CD-ROM 3101 that is inserted into the CD-ROM drive 3012, and be transferred to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or directly from a network.

The program does not necessarily have to include, for example, an operating system (OS) or a third party program to cause the computer 301 to execute the functions of the bilingual phrase learning apparatus and the like in the foregoing embodiments. The program may only include a command portion to call an appropriate function (module) in a controlled mode and obtain the desired results. The manner in which the computer system 300 operates is well known, and, thus, a detailed description thereof has been omitted.

Furthermore, the computer that executes this program may be a single computer, or may be multiple computers. That is to say, centralized processing may be performed, or distributed processing may be performed.

Furthermore, in the foregoing embodiments, it will be appreciated that two or more communication parts (a terminal information transmitting unit, a terminal information receiving unit, etc.) in one apparatus may be physically realized by one medium.

Furthermore, in the foregoing embodiments, each processing (each function) may be realized as centralized processing using a single apparatus (system), or may be realized as distributed processing using multiple apparatuses.

It will be appreciated that the present invention is not limited to the embodiments set forth herein, and various modifications are possible within the scope of the present invention.

### INDUSTRIAL APPLICABILITY

As described above, the bilingual phrase learning apparatus according to the present invention has an effect that a translation model can be easily enhanced in a stepwise manner, by using a translation model generated from an added translation corpus in a state of being integrated to an original translation model, and, thus, this apparatus is useful as an apparatus for machine translation and the like.

### LIST OF REFERENCE NUMERALS

1, 2 Bilingual phrase learning apparatus
3 Statistical machine translation apparatus
100 Bilingual information storage unit
101 Phrase table
102 Phrase appearance frequency information storage unit
103 Symbol appearance frequency information storage unit
104 Translation corpus accepting unit
105 Translation corpus accumulating unit
106 Phrase table initializing unit
107 Generated phrase pair acquiring unit
108 Phrase appearance frequency information updating unit
109 Symbol acquiring unit
110 Symbol appearance frequency information updating unit
111 Partial phrase pair generating unit
112 New phrase pair generating unit
113 Control unit
114 Score calculating unit
115 Parsing unit
116 Phrase table updating unit
117 Tree updating unit
201 Translation corpus generating unit

1. A bilingual phrase learning apparatus, comprising:
a bilingual information storage unit in which N translation corpuses (N is a natural number of 2 or more) each having one or more pieces of bilingual information, each of which has a pair of original and translated sentences and a tree structure of the pair of original and translated sentences, are stored;
a phrase table in which one or more scored phrase pairs each having a phrase pair, which is a pair of a first language phrase having one or more words in a first language and a second language phrase having one or more words in a second language, and a score, which is information regarding an appearance probability of the phrase pair, are stored for each translation corpus;
a phrase appearance frequency information storage unit in which one or more pieces of phrase appearance frequency information each having a phrase pair and F appearance frequency information, which is information regarding an appearance frequency of the phrase pair, are stored for each translation corpus;
a symbol appearance frequency information storage unit in which one or more pieces of symbol appearance frequency information each having a symbol for identifying a method for generating a new phrase pair and S appearance frequency information, which is information regarding an appearance frequency of the symbol, are stored;
a generated phrase pair acquiring unit that acquires, for each translation corpus, a phrase pair having a first language phrase and a second language phrase, using the one or more pieces of phrase appearance frequency information;
a phrase appearance frequency information updating unit that, in a case where a phrase pair has been acquired, increases the F appearance frequency information corresponding to the phrase pair, by a predetermined value;
a symbol acquiring unit that, in a case where a phrase pair has not been acquired, acquires one symbol, using the one or more pieces of symbol appearance frequency information;
a symbol appearance frequency information updating unit that increases the S appearance frequency information corresponding to the symbol acquired by the symbol acquiring unit, by a predetermined value;
a partial phrase pair generating unit that, in a case where a phrase pair has not been acquired, generates two phrase pairs smaller than the phrase pair intended to be acquired;
a new phrase pair generating unit that performs one of first processing, second processing, and third processing, according to the symbol acquired by the symbol acquiring unit, the first processing being processing that generates a new phrase pair, the second processing being processing that generates two smaller phrase pairs, and generates one phrase pair having a new first language phrase obtained by integrating, in forward order, two first language phrases forming the generated two phrase pairs and a new second language phrase obtained by integrating, in forward order, two second language phrases forming the two phrase pairs, using the one or more pieces of phrase appearance frequency information, and third processing being processing that generates two smaller phrase pairs, and generates one phrase pair having a new first language phrase obtained by integrating, in forward order, two first language phrases forming the generated two phrase pairs and a new second language phrase obtained by integrating, in inverse order, two second language phrases forming the two phrase pairs, using the one or more pieces of phrase appearance frequency information;
a control unit that gives an instruction to recursively perform the processing by the phrase appearance frequency information updating unit, the symbol acquiring unit, the symbol appearance frequency information updating unit, the partial phrase pair generating unit, and the new phrase pair generating unit, on the phrase pair generated by the new phrase pair generating unit;
a score calculating unit that calculates a score of each phrase pair in the phrase table, using the one or more pieces of phrase appearance frequency information stored in the phrase appearance frequency information storage unit; and
a phrase table updating unit that accumulates the score calculated by the score calculating unit, in association with the corresponding phrase pair;
wherein, in a case of calculating a score of each phrase pair acquired from a j-th translation corpus (2≦j≦N), the score calculating unit calculates a score of each phrase pair corresponding to the j-th translation corpus, using the one or more pieces of phrase appearance frequency information corresponding to a (j−1)-th translation corpus.

2. The bilingual phrase learning apparatus according to claim 1,
wherein one or more translation corpuses are stored in the bilingual information storage unit,
the bilingual phrase learning apparatus further comprises:
a translation corpus accepting unit that accepts a translation corpus; and
a translation corpus accumulating unit that accumulates the translation corpus accepted by the translation corpus accepting unit, in the bilingual information storage unit;
after the translation corpus accumulating unit accumulates the accepted translation corpus in the bilingual information storage unit, the control unit gives an instruction to perform the processing by the generated phrase pair acquiring unit, the phrase appearance frequency information updating unit, the symbol acquiring unit, the symbol appearance frequency information updating unit, the partial phrase pair generating unit, and the new phrase pair generating unit, on the translation corpus, and
in a case of calculating a score of each phrase pair acquired from the translation corpus accepted by the translation corpus accepting unit, the score calculating unit calculates a score of each phrase pair corresponding to the translation corpus accepted by the translation corpus accepting unit, using the one or more pieces of phrase appearance frequency information corresponding to one translation corpus among the one or more translation corpuses stored in the bilingual information storage unit before the translation corpus accumulating unit accumulates the translation corpus.

3. The bilingual phrase learning apparatus according to claim 1, further comprising: a translation corpus generating unit that splits two or more pairs of original and translated sentences into N groups, and accumulates N translation corpuses generated by acquiring tree structures of pairs of original and translated sentences from the pairs of original and translated sentences in the respective groups, in the bilingual information storage unit;
wherein, in a case of calculating a score of each phrase pair acquired from one translation corpus, the score calculating unit calculates a score of each phrase pair corresponding to the one translation corpus, using the one or more pieces of phrase appearance frequency information corresponding to a translation corpus different from the one translation corpus.

4. The bilingual phrase learning apparatus according to claim 1, wherein the score calculating unit calculates a score of each phrase pair corresponding to a translation corpus, using a hierarchical Chinese restaurant process following Expression 9:
$$\begin{matrix}P ( 〈 f , e 〉 ; 〈 F , E 〉 ) = \frac{{c}_{〈 f , e 〉}^{J} {d}^{J} \times {t}_{〈 f , e 〉}^{J}}{{C}^{J} + {s}^{J}} + \\ \frac{{s}^{J} + {d}^{J} \times {T}^{J}}{{C}^{J} + {s}^{J}} \times \frac{{c}_{〈 f , e 〉}^{J - 1} - {d}^{J - 1} \times {t}_{〈 f , e 〉}^{J - 1}}{{C}^{J - 1} + {s}^{J - 1}} … + \\ {\prod }_{{j}^{′} = j + 1}^{J} \frac{{s}^{{j}^{′}} + {d}^{{j}^{′}} \times {T}^{{j}^{′}}}{{C}^{{j}^{′}} + {s}^{{j}^{′}}} \times \\ \frac{{c}_{〈 f , e 〉}^{j} - {d}^{j} \times {t}_{〈 f , e 〉}^{j}}{{C}^{j} + {s}^{j}} … + \\ {\prod }_{{j}^{′} = 1}^{J} \frac{{s}^{{j}^{′}} + {d}^{{j}^{′}} \times {T}^{{j}^{′}}}{{C}^{{j}^{′}} + {s}^{{j}^{′}}} \times {P}_{base}^{1} ( 〈 f , e 〉 )\end{matrix} \qquad Expression 9$$
(where f is a phrase in a source language, e is a phrase in a target language, F is a source language sentence, E is a target language sentence, C^{j} is all customers in j-th bilingual data <F,E>, s^{j} is a strength corresponding to the j-th bilingual data, d^{j} is a discount corresponding to the j-th bilingual data, T^{j} is all tables in the bilingual data <F,E>, c^{j}_{<f,e>} is the number of customers corresponding to each <f,e> in the j-th bilingual data, t^{j} is the number of tables corresponding to each <f,e> in the j-th bilingual data, and P_{base}(<fᵢ,eᵢ>) is a prior probability of a model estimated in advance).

5. A statistical machine translation apparatus, comprising:
a phrase table learned by the bilingual phrase learning apparatus according to claim 1;
an accepting unit that accepts a sentence in a first language having one or more words;
a phrase acquiring unit that extracts one or more phrases from the sentence accepted by the accepting unit, and acquires one or more phrases in a second language from the phrase table, using a score in the phrase table;
a sentence constructing unit that constructs a sentence in the second language, from the one or more phrases acquired by the phrase acquiring unit; and
an output unit that outputs the sentence constructed by the sentence constructing unit.

6. A bilingual phrase learning method realized by: a bilingual information storage unit in which N translation corpuses (N is a natural number of 2 or more) each having one or more pieces of bilingual information, each of which has a pair of original and translated sentences and a tree structure of the pair of original and translated sentences, are stored; a phrase table in which one or more scored phrase pairs each having a phrase pair, which is a pair of a first language phrase having one or more words in a first language and a second language phrase having one or more words in a second language, and a score, which is information regarding an appearance probability of the phrase pair, are stored; a phrase appearance frequency information storage unit in which one or more pieces of phrase appearance frequency information each having a phrase pair and F appearance frequency information, which is information regarding an appearance frequency of the phrase pair, are stored for each translation corpus; a symbol appearance frequency information storage unit in which one or more pieces of symbol appearance frequency information each having a symbol for identifying a method for generating a new phrase pair and S appearance frequency information, which is information regarding an appearance frequency of the symbol, are stored; a phrase appearance frequency information updating unit; a symbol acquiring unit; a symbol appearance frequency information updating unit; a partial phrase pair generating unit; a new phrase pair generating unit; a control unit; a score calculating unit; and a phrase table updating unit; comprising:
a generated phrase pair acquiring step of the generated phrase pair acquiring unit acquiring, for each translation corpus, a phrase pair having a first language phrase and a second language phrase, using the one or more pieces of phrase appearance frequency information;
a phrase appearance frequency information updating step of the phrase appearance frequency information updating unit, in a case where a phrase pair has been acquired, increasing the F appearance frequency information corresponding to the phrase pair, by a predetermined value;
a symbol acquiring step of the symbol acquiring unit, in a case where a phrase pair has not been acquired, acquiring one symbol, using the one or more pieces of symbol appearance frequency information;
a symbol appearance frequency information updating step of the symbol appearance frequency information updating unit increasing the S appearance frequency information corresponding to the symbol acquired in the symbol acquiring step, by a predetermined value;
a partial phrase pair generating step of the partial phrase pair generating unit, in a case where a phrase pair has not been acquired, generating two phrase pairs smaller than the phrase pair intended to be acquired;
a new phrase pair generating step of the new phrase pair generating unit performing one of first processing, second processing, and third processing, according to the symbol acquired in the symbol acquiring step, the first processing being processing that generates a new phrase pair, the second processing being processing that generates two smaller phrase pairs, and generates one phrase pair having a new first language phrase obtained by integrating, in forward order, two first language phrases forming the generated two phrase pairs and a new second language phrase obtained by integrating, in forward order, two second language phrases forming the two phrase pairs, using the one or more pieces of phrase appearance frequency information, and third processing being processing that generates two smaller phrase pairs, and generates one phrase pair having a new first language phrase obtained by integrating, in forward order, two first language phrases forming the generated two phrase pairs and a new second language phrase obtained by integrating, in inverse order, two second language phrases forming the two phrase pairs, using the one or more pieces of phrase appearance frequency information;
a control step of the control unit giving an instruction to recursively perform the processing in the phrase appearance frequency information updating step, the symbol acquiring step, the symbol appearance frequency information updating step, the partial phrase pair generating step, and the new phrase pair generating step, on the phrase pair generated in the new phrase pair generating step;
a score calculating step of the score calculating unit calculating a score of each phrase pair in the phrase table, using the one or more pieces of phrase appearance frequency information stored in the phrase appearance frequency information storage unit; and
a phrase table updating step of the phrase table updating unit accumulating the score calculated in the score calculating step, in association with the corresponding phrase pair;
wherein, in the score calculating step, in a case of calculating a score of each phrase pair acquired from a j-th translation corpus (2≦j≦N), a score of each phrase pair corresponding to the j-th translation corpus is calculated using the one or more pieces of phrase appearance frequency information corresponding to a (j−1)-th translation corpus.

7. A storage medium in which a program is stored,
the program causing the storage medium to have: a bilingual information storage unit in which N translation corpuses (N is a natural number of 2 or more) each having one or more pieces of bilingual information, each of which has a pair of original and translated sentences and a tree structure of the pair of original and translated sentences, are stored; a phrase table in which one or more scored phrase pairs each having a phrase pair, which is a pair of a first language phrase having one or more words in a first language and a second language phrase having one or more words in a second language, and a score, which is information regarding an appearance probability of the phrase pair, are stored; a phrase appearance frequency information storage unit in which one or more pieces of phrase appearance frequency information each having a phrase pair and F appearance frequency information, which is information regarding an appearance frequency of the phrase pair, are stored for each translation corpus; and a symbol appearance frequency information storage unit in which one or more pieces of symbol appearance frequency information each having a symbol for identifying a method for generating a new phrase pair and S appearance frequency information, which is information regarding an appearance frequency of the symbol, are stored; and
causing a computer to execute:
a generated phrase pair acquiring step of acquiring, for each translation corpus, a phrase pair having a first language phrase and a second language phrase, using the one or more pieces of phrase appearance frequency information;
a phrase appearance frequency information updating step of, in a case where a phrase pair has been acquired, increasing the F appearance frequency information corresponding to the phrase pair, by a predetermined value;
a symbol acquiring step of, in a case where a phrase pair has not been acquired, acquiring one symbol, using the one or more pieces of symbol appearance frequency information;
a symbol appearance frequency information updating step of increasing the S appearance frequency information corresponding to the symbol acquired in the symbol acquiring step, by a predetermined value;
a partial phrase pair generating step of, in a case where a phrase pair has not been acquired, generating two phrase pairs smaller than the phrase pair intended to be acquired;
a new phrase pair generating step of performing one of first processing, second processing, and third processing, according to the symbol acquired in the symbol acquiring step, the first processing being processing that generates a new phrase pair, the second processing being processing that generates two smaller phrase pairs, and generates one phrase pair having a new first language phrase obtained by integrating, in forward order, two first language phrases forming the generated two phrase pairs and a new second language phrase obtained by integrating, in forward order, two second language phrases forming the two phrase pairs, using the one or more pieces of phrase appearance frequency information, and third processing being processing that generates two smaller phrase pairs, and generates one phrase pair having a new first language phrase obtained by integrating, in forward order, two first language phrases forming the generated two phrase pairs and a new second language phrase obtained by integrating, in inverse order, two second language phrases forming the two phrase pairs, using the one or more pieces of phrase appearance frequency information;
a control step of giving an instruction to recursively perform the processing in the phrase appearance frequency information updating step, the symbol acquiring step, the symbol appearance frequency information updating step, the partial phrase pair generating step, and the new phrase pair generating step, on the phrase pair generated in the new phrase pair generating step;
a score calculating step of calculating a score of each phrase pair in the phrase table, using the one or more pieces of phrase appearance frequency information stored in the phrase appearance frequency information storage unit; and
a phrase table updating step of accumulating the score calculated in the score calculating step, in association with the corresponding phrase pair;
wherein, in the score calculating step, in a case of calculating a score of each phrase pair acquired from a j-th translation corpus (2≦j≦N), a score of each phrase pair corresponding to the j-th translation corpus is calculated using the one or more pieces of phrase appearance frequency information corresponding to a (j−1)-th translation corpus.
